(19) United States
(12) Patent Application Publication
(10) Pub. No.: US 2026/0229062 A1
(43) Pub. Date: Aug. 6, 2026

(54) SYSTEMS AND METHODS FOR FACILITATING METADATA-DRIVEN INTERACTIVE PLAYBACK

(71) Applicant: Neotericc LLC, LONE TREE, CO (US)

(72) Inventor: Patrick L. Carter, Lone Tree, CO (US)

(73) Assignee: Neotericc LLC, LONE TREE, CO (US)

(21) Appl. No.: 19/435,946

(22) Filed: Dec. 30, 2025

Related U.S. Application Data
(60) Provisional application No. 63/754,577, filed on Feb. 6, 2025.

(51) Int. Cl. G06V 40/20; G06T 15/00; G06T 17/00

(52) U.S. Cl. CPC G06V 40/23; G06T 15/005; G06T 17/00

(57) ABSTRACT

The present disclosure provides a method for facilitating metadata-driven interactive playback. Further, the method may include receiving one or more activity data representing one or more contents associated with one or more physical activities. Further, the method may include obtaining a key supplementary attribute data based on the one or more activity data. Further, the key supplementary attribute data represents one or more key attributes supplementing the one or more contents. Further, the method may include processing each of the one or more activity data and the key supplementary attribute data for generating one or more enhanced activity data. Further, the one or more enhanced activity data represents the one or more contents augmented with the one or more key attributes. Further, the method may include transmitting the one or more enhanced activity data to one or more devices.

### REFERENCE TO RELATED APPLICATIONS

This application claims the benefit of U.S. Provisional Patent Application No. 63/754,577, titled “SYSTEMS AND METHODS OF PROVISIONING AN ENHANCED ACTIVITY DATA BASED ON AN ACTIVITY”, filed on Feb. 06, 2025, which is incorporated by reference herein in its entirety.

### FIELD OF DISCLOSURE

The present disclosure relates to the field of data processing. More specifically, the present disclosure relates to systems and methods for facilitating metadata-driven interactive playback.

### BACKGROUND

The fields of video processing, activity analysis, biomechanics evaluation, and interactive media enrichment are of increasing importance as digital content platforms, sports analytics systems, and performance-monitoring environments continue to grow in complexity and scale. As data-driven assessment becomes central to training, coaching, health monitoring, and automated analysis, there is a growing emphasis on systems capable of extracting meaningful insights from video-based activity data in a manner that is accurate, efficient, and adaptable across a variety of performance contexts.

As digital media ecosystems expand, a desirable aspect is to achieve a level of automation and intelligence within activity-analysis workflows that enables precise identification of relevant moments, dynamic characterization of performance attributes, and seamless augmentation of video content with analytical or contextual information. Further, a desirable aspect includes allowing such capabilities to operate in real time or near real time, and to support interactive engagement by users who may wish to explore an activity from multiple perspectives, transition between meaningful moments, or access performance-related insights without requiring specialized hardware or extensive manual setup.

However, existing systems often face significant challenges in achieving the said objectives. In many instances, platforms struggle to interpret complex activity sequences reliably, resulting in limited ability to identify salient phases or transitions within a performance. In some cases, analytical data associated with an activity may be isolated from the video content itself, thereby restricting the user’s ability to navigate, compare, or understand the underlying performance in an integrated manner. Systems may also encounter difficulties in aligning analytical information with temporal or spatial aspects of the activity, reducing the accuracy of insights presented to users. Furthermore, conventional workflows may be rigid, offering limited adaptability or personalization, hindering the usefulness of the system across diverse activity types, user profiles, or performance scenarios.

Additional limitations may arise where video playback technologies lack mechanisms to incorporate advanced insights, predictive models, comparative visualizations, or dynamic adjustments based on real-time computational conditions. Such constraints may impede the delivery of a cohesive, interactive experience that effectively merges video content with analytical, biomechanical, or contextual information. As a result, users may be required to rely on fragmented tools, manual interpretation, or insufficiently synchronized data sources, which reduces the overall efficiency and accuracy of activity evaluation.

Therefore, there is a need for improved systems and methods for facilitating metadata-driven interactive playback that may overcome one or more of the preceding problems.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter’s scope.

The present disclosure provides a method for facilitating metadata-driven interactive playback. Further, the method may include receiving, using a communication device, one or more activity data from one or more devices. Further, the one or more activity data represent one or more contents associated with one or more physical activities. Further, the method may include obtaining, using a processing device, a key supplementary attribute data based on the one or more activity data. Further, the key supplementary attribute data represents one or more key attributes supplementing the one or more contents. Further, the method may include processing, using the processing device, each of the one or more activity data and the key supplementary attribute data. Further, the method may include generating, using the processing device, one or more enhanced activity data based on the processing of each of the one or more activity data and the key supplementary attribute data. Further, the one or more enhanced activity data represent the one or more contents augmented with the one or more key attributes. Further, the method may include storing, using a storage device, each of the one or more activity data and the one or more enhanced activity data. Further, the method may include transmitting, using the communication device, the one or more enhanced activity data to the one or more devices.

The present disclosure provides a system for facilitating metadata-driven interactive playback. Further, the system may include a communication device. Further, the communication device may be configured for receiving one or more activity data from one or more devices. Further, the one or more activity data represent one or more contents associated with one or more physical activities. Further, the communication device may be configured for transmitting one or more enhanced activity data to the one or more devices. Further, the system may include a processing device communicatively coupled with the communication device. Further, the processing device may be configured for obtaining a key supplementary attribute data based on the one or more activity data. Further, the key supplementary attribute data represents one or more key attributes associated with the one or more physical activities. Further, the processing device may be configured for processing each of the one or more activity data and the key supplementary attribute data. Further, the processing device may be configured for generating the one or more enhanced activity data based on the processing of each of the one or more activity data and the key supplementary attribute data. Further, the one or more enhanced activity data represent the one or more contents augmented with the one or more key attributes. Further, the system may include a storage device communicatively coupled with the processing device. Further, the storage device may be configured for storing each of the one or more activity data and the one or more enhanced activity data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

The drawings presented with this disclosure may illustrate representative and non-limiting arrangements of hardware components, software modules, artificial intelligence subsystems, machine learning architectures, data processing pipelines, user interfaces, network topologies, and memory arrangements that may be used to understand embodiments of the present subject matter. They may depict functional or conceptual layouts intended to facilitate explanation of the disclosed principles. The geometric appearance, dimensional proportions, ordering, grouping, and naming of elements within the drawings are not intended to imply any restriction on implementation. The drawings may schematically portray computing environments containing client devices, servers, distributed computing clusters, communication networks, storage systems, or artificial intelligence models arranged for training, inference, or combined operations. The drawings may include simplified symbolic representations of algorithmic processes, workflows, blocks, or modules; such symbolic representations are treated as abstractions of underlying hardware and software operations rather than literal structural requirements. Similarly, lines connecting components may represent logical associations, communication pathways, or data relationships rather than any specific physical wiring or layout. These figures may also illustrate non-exhaustive examples of operational stages, sequencing, or interactions among artificial intelligence components such as encoders, decoders, generators, discriminators, featurizers, transformers, or safety-validation modules. Any specific combination or configuration shown is presented for explanatory clarity only. Additional drawings, alternative views, or more granular depictions may be used without affecting the scope of the claims.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 is a block diagram illustrating a machine-learning system 300 for implementing various embodiments of this disclosure, in accordance with some embodiments.

FIG. 4 illustrates a flowchart of a method 400 for facilitating metadata-driven interactive playback, in accordance with some embodiments.

FIG. 5 illustrates a flowchart of a method 500 for facilitating metadata-driven interactive playback including generating, using the processing device 904, a comparison data, in accordance with some embodiments.

FIG. 6 illustrates a flowchart of a method 600 for facilitating metadata-driven interactive playback including generating, using the processing device 904, a ghosted transition data, in accordance with some embodiments.

FIG. 7 illustrates a flowchart of a method 700 for facilitating metadata-driven interactive playback including generating, using the processing device 904, a three-dimensional model data, in accordance with some embodiments.

FIG. 8 illustrates a flowchart of a method 800 for facilitating metadata-driven interactive playback including retrieving, using the storage device 906, an API endpoint data corresponding to an API endpoint associated with at least one external database comprising the additional information, in accordance with some embodiments.

FIG. 9 illustrates a block diagram of a system 900 for facilitating metadata-driven interactive playback, in accordance with some embodiments.

FIG. 10 illustrates a block diagram of the system 900 for facilitating metadata-driven interactive playback including a coach device 1002, in accordance with some embodiments.

FIG. 11 illustrates a flowchart of a method 1100 for facilitating metadata-driven interactive playback including receiving, using the communication device 902, a response data from the external database device, in accordance with some embodiments.

FIG. 12 illustrates a flowchart of a method 1200 for facilitating metadata-driven interactive playback including determining, using the processing device 904, at least one attribute placement data, in accordance with some embodiments.

FIG. 13 illustrates the one or more devices 908 presenting the one or more enhanced activity data, in accordance with some embodiments.

FIG. 14 illustrates a flowchart of a method 1400 of provisioning an enhanced activity data based on an activity, in accordance with some embodiments.

FIG. 15 illustrates a flowchart of a method 1500 of provisioning an enhanced activity data based on an activity including generating, using the processing device 904, a spatial insight data, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

The detailed description that follows may provide a framework for describing computer-implemented systems, artificial intelligence systems, distributed learning infrastructures, data processing pipelines, and hardware and software arrangements suitable for implementing embodiments shown in the drawings. Terms such as processing, computing, determining, or generating refer to actions performed by computing systems or electronic devices that manipulate data represented as physical signals, stored values, or encoded information within registers, memory structures, and storage devices.

The present disclosure contemplates implementations involving artificial intelligence, machine learning, distributed computation, and computer-implemented systems operating upon data represented as physical electronic or optical signals. Descriptions of processing, analyzing, determining, transforming, encoding, decoding, generating, inferring, synthesizing, modifying, storing, retrieving, ranking, filtering, validating, classifying, or otherwise manipulating information are to be understood as referring to the actions of computing systems, electronic devices, or computational circuits that manipulate such signals in memory elements, registers, buffers, or storage media. These operations may be performed by general-purpose processors, specialized processors, machine learning accelerators, or combinations thereof.

The disclosure contemplates implementations in which artificial intelligence systems perform perception, synthesis, inference, prediction, or generation of information using models whose configurations may evolve based on training, feedback, or adaptive learning processes. A model may initially be configured with a set of parameters and architectural structures that define its behavior, and this configuration may change automatically as the model encounters training inputs, validation data, reference data, or instructor-provided feedback. A machine learning model may modify its internal state through optimization techniques, gradient updates, reinforcement signals, vector transformations, attention mechanisms, latent variable adjustments, embedding refinements, or other learning operations executed electronically. Such modifications may occur over extended cycles, partial cycles, or continual learning sequences without explicit intervention by a human.

The disclosure contemplates systems involving data ingestion pipelines that gather input from sources including but not limited to sensor signals, event streams, text data, image data, audio data, video data, structured and unstructured repositories, application logs, telemetric feeds, network services, or human-generated content. Ingestion functions may include filtering, normalization, augmentation, segmentation, batching, tokenization, windowing, compression, encryption, decryption, hashing, deduplication, contextualization, and mapping to internal formats. Intermediate components may transform this data into derived representations, including embeddings, latent encodings, feature tensors, multi-modal joint representations, or contextual vectors suitable for use by downstream modeling engines. These transformations may be performed using neural networks, statistical encoders, dimensionality-reduction algorithms, or hybrid computational modules.

The disclosure contemplates machine learning systems that may employ advanced architectures such as transformer networks, encoder-decoder stacks, mixture-of-expert structures, diffusion models, recurrent networks, convolutional hierarchies, attention-based models, retrieval-augmented architectures, cross-modal alignment engines, graph neural networks, probabilistic models, auto-encoding frameworks, or hybrid symbolic-neural systems. Such models may implement deep layers configured to perform operations including attention calculations, feed-forward projections, gating operations, positional encoding, normalization steps, multi-head routing, sequential decoding, or latent pathway selection. Multi-modal systems may combine textual, visual, auditory, sensory, or structured inputs within joint representational spaces. Embeddings may be learned from large corpora or multi-modal datasets and may encode semantic, syntactic, structural, temporal, spatial, or contextual relationships across modalities. These embeddings may be dynamically updated as the system encounters new information, thereby improving consistency, expressiveness, or alignment with real-world contexts.

The disclosure contemplates training processes that may involve supervised learning, unsupervised learning, semi-supervised learning, self-supervised learning, reinforcement learning, preference optimization, curriculum-based learning, active learning, or continual learning. Training operations may include forward passes through the model, backward propagation of gradients, update steps using optimization algorithms, adaptive learning-rate scheduling, regularization steps, loss-function evaluation, and check pointing of intermediate states. Training datasets may include real-world data, synthetic data, simulated data, augmented data, or mixtures thereof. Validation procedures may evaluate performance metrics, generalization behavior, safety constraints, or compliance with domain-specific criteria. In some implementations, refinement cycles may incorporate human-in-the-loop interventions, reward model shaping, safety evaluator feedback, or guided corrections.

The disclosure contemplates distributed or federated execution in which computation is partitioned across multiple hardware devices, regions, or clusters. Certain operations may occur at edge devices for low latency, while others may be delegated to remote servers, cloud clusters, datacenters, or specialized compute fabrics. Components may communicate over wired or wireless networks supporting data exchange, synchronization, replication, or model-state updates. Distributed learning processes may synchronize gradients, coordinate model versions, merge updates across shards, or exchange activation values within parallel training regimes. Distributed inference may involve routing requests across replicas, balancing load through orchestration layers, or selecting model pathways dynamically. Network connections may include encryption, authentication, secure session management, or routing protocols appropriate for maintaining privacy, integrity, or availability.

The disclosure contemplates orchestration layers capable of managing complex workflows involving model invocation, tool invocation, external data retrieval, decision routing, fallback selection, multi-model aggregation, post-processing evaluation, or safety governance. Orchestration environments may evaluate contextual signals, metadata, user characteristics, or policy constraints to determine which models, subsystems, or computational branches should be executed. Such environments may dynamically alter execution pathways based on estimated performance, resource availability, model confidence, safety risk, or real-time system health. Post-processing components may evaluate generated outputs for compliance with content policies, statutory requirements, operational constraints, or domain-specific decision rules.

The disclosure contemplates safety-oriented components that evaluate model outputs or intermediate representations for consistency with safety criteria, quality thresholds, regulatory considerations, factual accuracy constraints, domain restrictions, or alignment requirements. Safety modules may employ auxiliary models, discriminators, rule sets, statistical detectors, confidence estimators, or hybrid evaluators to identify undesirable outputs. These modules may trigger remediation actions including output modification, output rejection, re-routing through alternate inference pathways, invocation of corrective models, or escalation for human review. Safety processes may incorporate real-time validation, contextual scoring, adversarial robustness analysis, anomaly detection, or controlled generation constraints.

The disclosure contemplates governance structures including policy managers, audit loggers, compliance trackers, version controllers, and provenance systems that associate model outputs with contextual metadata, historical signals, update events, training sources, or safety evaluations. Systems may maintain lineage records documenting which model version, configuration state, or training dataset contributed to an outcome. Governance modules may ensure that system behavior aligns with formal requirements such as fairness principles, legal obligations, industry standards, or institutional guidelines.

The disclosure contemplates storage and memory systems capable of storing model parameters, datasets, embeddings, logs, metrics, checkpoints, execution traces, and auxiliary information used to configure or interpret model behavior. These storage systems may include magnetic media, semiconductor memory, optical media, solid-state arrays, distributed storage fabrics, or hybrid memory hierarchies. Storage media may contain instructions, configurations, or data structures that, when accessed by a computing device, configure that device to carry out the operations described herein. Such media may include executables, bytecode, machine code, firmware, microcode, program modules, configuration files, architectural descriptors, or schema definitions.

The disclosure contemplates user interfaces that permit human operators to view model outputs, initiate tasks, modify configurations, inspect metrics, interact with logs, evaluate safety signals, or guide system adaptation. Interfaces may be multimodal and may support textual input, speech commands, visual interaction, gesture control, or programmatic invocation through APIs. Administrative interfaces may allow for reviewing system performance, tuning operational thresholds, enabling or disabling features, monitoring resource use, examining generated content, or initiating refinement workflows.

The disclosure contemplates systems in which instructions are executed entirely on a single device, partially on multiple devices, or cooperatively across remote and local environments. Code may execute directly on hardware, within firmware, inside virtual machines, inside containers, or through any combination of software and hardware interactions. Computational instructions may be stored locally, transferred via communication networks, or streamed from remote systems. Implementations may involve software executing on general-purpose processors, specialized logic circuits performing equivalent functions, or hybrid mechanisms that combine hardware acceleration with software guidance.

Interpretation of terms in this disclosure is governed by principles commonly applied by persons of ordinary skill in the relevant field. Technical and scientific terms used herein should be understood in a manner consistent with their usage in the field of artificial intelligence, machine learning, computing, networking, data storage, or any related discipline. Terms describing functionality should not be interpreted as strictly structural unless explicitly stated. Phrases such as configured to, adapted to, operable to, or capable of indicate permissible functionality rather than structural limitations. Terms such as a or an encompass one or more unless clearly contradicted by context. Terms joined by or should be interpreted as inclusive, and terms joined by and should be interpreted as collective.

The description set forth herein provides a broad and flexible framework intended to support a wide range of computer-implemented, machine-learning-enabled, distributed, and multimodal embodiments. Variations may include reallocation of tasks, substitution of algorithms, reconfiguration of models, changes to pipeline ordering, or adoption of alternate hardware. No combination or arrangement mentioned herein should be regarded as required unless explicitly stated. The scope of protection is established by the claims, interpreted in light of this description.

The present disclosure contemplates implementations that employ advanced mathematical frameworks characteristic of modern artificial intelligence systems. Machine learning models may be conceptualized as parameterized functions that map elements of an input space to elements of an output space. Such a function may be defined over real-valued, complex-valued, vector-valued, tensor-valued, or mixed-modal domains. The model may implement successive transformations applied to an ordered set of input vectors using compositions of linear operators, nonlinear activations, attention functions, normalization operations, and dimensional projections.

Model parameters may be represented as ordered collections of real-valued scalars arranged into structures such as matrices, tensors, kernels, filters, or embeddings. These parameters may be optimized by minimizing a loss functional defined over an expected distribution of input-output pairs. The optimization process may involve computing gradients of the loss functional with respect to each model parameter, followed by an update step that serves to reduce the value of the loss functional. Gradient computation may use automatic differentiation frameworks that symbolically or numerically propagate partial derivatives backward through a computational graph.

Attention mechanisms may employ a similarity measure between projected query vectors and projected key vectors. This similarity measure may yield a weight distribution over contextual elements. The weighted combination of projected value vectors may form an attention output that is subsequently transformed through additional layers. Multiple independent attention heads may be aggregated to capture heterogeneous relationships within the input domain. Cross-attention mechanisms may operate similarly but with distinct source and target sequences.

Normalization steps may rescale intermediate representations using learned scaling and shifting coefficients. Activation functions may introduce nonlinearity by applying element-wise transformations selected to ensure differentiability and expressive capacity. Residual pathways may combine transformed and untransformed representations to facilitate stable gradient propagation under deep compositions. Positional encodings or structural embeddings may inject ordering, spatial, temporal, or relational information into otherwise permutation-invariant architectures.

Multi-modal models may operate over domains that combine text, image, audio, video, sensor, or structured signals. These domains may be embedded into a common vector space through learned projection operators. Joint training processes may enforce alignment constraints that minimize representational divergence between modalities while preserving intra-modal semantics.

Diffusion frameworks may model data generation as the reversal of a stochastic corruption process. A forward process may incrementally add noise to data samples, while a learned reverse process may approximate the time-reversed conditional probability distribution. The reverse process may be parameterized by a neural network trained to denoise intermediate states. Continuous-time formulations may model this process using stochastic differential equations whose drift and diffusion terms are learned through score-matching or related techniques.

Reinforcement-based procedures may model learning as an optimization of expected reward under a policy function. The policy may produce distributions over actions given a latent or explicit representation of the environment state. Policy gradients may be estimated from sampled trajectories, and advantage estimators may reduce variance of such gradients. Value functions may approximate the expected cumulative reward, and these approximations may be updated through temporal-difference learning.

Generative models may be expressed in probabilistic terms as joint or conditional distributions parameterized by neural architectures. Such models may perform sampling by iteratively drawing latent variables from a learned distribution and transforming those variables into output space. Variational models may introduce auxiliary latent variables whose posterior distributions are approximated through recognition functions that optimize an evidence-bound objective.

Matrix decompositions, spectral analysis, manifold learning, kernel operators, and other mathematical constructs may be incorporated to improve expressiveness, stability, or computational efficiency. Training may involve sophisticated schedulers, trust-region constraints, adaptive learning-rate schemes, gradient-norm clipping, regularization penalties, entropy maximization, attention masking, or mixed-precision arithmetic.

All such mathematical constructs are conceptual, descriptive, and non-limiting. The disclosure encompasses any differentiable or non-differentiable optimization method, any discrete or continuous learning paradigm, and any representational transformation that may be understood by a person of ordinary skill in the field.

Further, the disclosure provides a computing environment which may include a combination of client devices, servers, distributed computing clusters, databases, external data sources, network nodes, and interface endpoints. Such an environment may support artificial intelligence workloads including perception, synthesis, inference, prediction, and generation, using hardware and software foundations designed for high-throughput and low-latency operation. Embodiments may involve the coordinated use of multiple machine learning models, whose configurations may evolve over time as they learn from training, validation, reference, or feedback data. Models may adjust their internal parameters through supervised, unsupervised, or reinforcement-based processes, allowing automatic electronic improvements to their performance based on input data and observed outcomes.

Further, the disclosure provides a computing device which may include processing units, memory elements, storage devices, system buses, high-speed controllers, low-speed controllers, and expansion interfaces. Processors may include general-purpose units, multi-core processors, vector processors, digital signal processors, tensor accelerators, neural accelerators, graphics engines, or various kinds of specialized integrated circuits including FPGAs, ASICs, ASSPs, SoCs, and CPLDs. A device may include system memory composed of volatile or non-volatile components such as RAM, DRAM, flash memory, ROM, or phase-change memory. The storage subsystem may include solid-state drives, magnetic disks, optical media, arrays of storage devices, and network-attached storage resources. Input and output mechanisms may include microphones, displays, keyboards, pointing devices, biometric sensors, gesture or touch interfaces, and actuators suitable for multimodal interaction with a user.

Further, the disclosure provides a machine-learning architecture which may include engines or modules such as a data input engine, data retrieval engine, data transform engine, featurization engine, modeling engine, generative engine, validation engine, feedback engine, and refinement engine. A data input pipeline may obtain structured or unstructured information from various sources, transform the information into model-compatible forms, and store such transformed data in memory or storage accessible to downstream components. A modeling engine may perform tasks such as model training, re-configuration, validation, and testing, executing iterative processes across multiple cycles or passes through training data. A predictive or generative engine may construct outputs based on intermediate representations, learned embeddings, or latent encodings generated by layers such as encoder-decoder structures, attention mechanisms, or multi-layer transformer architectures. Embeddings may represent discrete entities such as words, documents, or images as continuous vectors in high-dimensional spaces, capturing semantic or structural relationships useful for downstream tasks.

Further, the disclosure may provide a distributed or cloud-based operation may include multiple physical or virtual instances of computing devices, distributed across data centers or network boundaries. Functions may be partitioned across machines to achieve parallelism, redundancy, fault tolerance, or improved throughput. Distributed systems may use load balancing mechanisms to maintain stable processing, memory, or bandwidth utilization across clusters and avoid overload conditions. Such deployments may require communication over wired or wireless networks that implement a variety of protocols including HTTP, HTTPS, MQTT, CoAP, or any other suitable communication framework. Communication channels may include local networks, wide-area networks, personal-area networks, or global communication systems, potentially utilizing secure encrypted sessions such as SSL-based channels.

Further, the disclosure may provide an algorithm, process, or flow diagram which may include operations that may occur in sequences, reversed orders, concurrently, or in partially overlapping timelines, depending on the implementation. Blocks representing actions in a flowchart may correspond to program modules, instruction sequences, or hardware logic capable of performing the specified acts. Such operations may manipulate physical quantities such as electrical or magnetic signals stored or transferred among memory units, registers, storage devices, or communication media. Flow diagrams may be realized through software running on general-purpose processors, through dedicated hardware circuits, or through combinations of both.

Further, the disclosure may provide memory, storage, or programmatic constructs which may include program instructions encoded on computer-readable media including electronic, magnetic, optical, electromagnetic, semiconductor, or other tangible media. Examples include RAM, ROM, EEPROM, flash memory, magnetic disks, optical disks, and mechanical encoded structures such as punch cards or raised-pattern media. Such storage media may store instructions that, when executed, configure the memory and therefore configure the computing device itself, causing the device to perform functions described in association with the drawings.

Further, the disclosure may provide a user interface which may include graphical displays, dashboards, selection controls, input fields, monitoring elements, or multimodal interaction surfaces, allowing users to interact with computing systems in speech, touch, gesture, or other modalities. Such interfaces may be presented through client devices, server applications, or remote access platforms and may support visualization of model behavior, systems performance, or configuration parameters.

Further, described features may be combined, rearranged, omitted, or substituted without departing from the principles disclosed. Variations may involve distributing functionality across devices, merging components, implementing features in hardware rather than software, or employing alternative communication protocols. Many such variations and modifications are intended to fall within the scope of the disclosure as understood by persons skilled in the art.

The detailed description of the drawings therefore provides a foundation for describing technical, architectural, and operational aspects of embodiments, while allowing broad flexibility in how such embodiments may be implemented in practice. The scope of such embodiments is governed by the claims rather than the illustrative content of the drawings.

In some embodiments, a system consistent with this disclosure includes one or more client devices, one or more servers, and one or more data stores coupled by one or more networks. The client devices can include, without limitation, mobile phones, tablet computers, laptop or desktop computers, wearable devices, smart displays, vehicles, robots, or other computing platforms equipped with data processing hardware and memory hardware. The servers can include data servers, application servers, web servers, proxy servers, or cloud computing services that provide shared processing, storage, and networking resources. The data stores can include databases, object stores, file systems, or other repositories that persist configuration data, training data, logs, model artifacts, and other information.

The networks can include public and private networks, such as local area networks, wide area networks, and cloud networks, using wired or wireless communication links. The networks can provide routing, addressing, access control, encryption, and related functionality using standard or proprietary protocols.

Each computing device, whether a client device or a server, can include one or more processors, system memory, persistent storage, communication interfaces, and input or output devices. The processors can include general-purpose central processing units, graphics processing units, digital signal processors, microcontrollers, application-specific integrated circuits, field programmable gate arrays, or other programmable or fixed-function processing elements configured to execute instructions or perform logic operations. The memory can include volatile and non-volatile storage, such as random access memory and read-only memory. The persistent storage can include solid state drives, magnetic disks, optical media, or other non-transitory computer-readable media.

Program code executed by the processors can include operating systems, device drivers, libraries, and application programs, including components that implement portions of the methods described herein. Program code and data can be stored on computer-readable media and loaded into memory by standard mechanisms, such as boot loaders, installation programs, or update services.

Input devices can include keyboards, pointing devices, microphones, cameras, touch-sensitive surfaces, biometric sensors, and other sensors. Output devices can include displays, speakers, haptic devices, printers, and other actuators. Some devices can support multimodal interaction, allowing combined or sequential input and output through various modalities.

For purposes of this disclosure, artificial intelligence systems may include arrangements of software and hardware that perform tasks such as perception, prediction, planning, or generation based on input data. These systems can employ one or more models, such as statistical models, neural networks, decision trees, or other machine learning models. As used herein, a “model” can refer to a parameterized function, an ensemble of such functions, or a collection of cooperating components that process data and produce outputs.

In some embodiments, the system includes a data input engine that obtains data from one or more sources, such as application logs, sensor streams, structured databases, and unstructured content. The data input engine can retrieve, filter, aggregate, or transform the data into feature representations suitable for model consumption. Data sources can include training data, validation data, and reference data used to evaluate and calibrate model behavior.

A modeling engine can manage one or more training processes for one or more models. The modeling engine can select model architectures, initialize parameters, and apply training algorithms such as supervised learning, semi-supervised learning, unsupervised learning, reinforcement learning, or combinations thereof. The modeling engine can also manage hyper parameters, training schedules, and evaluation procedures across epochs or passes through the data.

The system can include a generative response engine or inference engine that receives prompts or other inputs and generates outputs using one or more models. For example, a natural language interface can receive a text prompt, embed or otherwise encode the prompt, process the encoded prompt using a transformer-based model or other sequence model, and generate a sequence of tokens that are decoded into an output. The engine can generate multiple candidate outputs and apply validation or ranking logic to select a final result according to quality, safety, or relevance criteria.

A feedback engine can collect explicit or implicit feedback signals, such as user ratings, corrective edits, or outcome metrics derived from downstream tasks. A refinement engine can use such feedback to adjust model parameters, routing logic, or policies, for example, by performing additional training steps, updating reward models, or modifying configuration parameters.

In certain embodiments, the disclosed techniques are applied to platforms that include sensors and actuators, such as vehicles, robots, or other machines. The platform can include a processor system that receives signals from cameras, LIDAR units, radar units, inertial sensors, and other devices, and produces control outputs for steering, propulsion, braking, or other actuators. Sensor data can be captured at various sampling rates and processed by perception models to detect and track objects and infer scene attributes.

Planning and control components can receive outputs from perception models along with route information, traffic rules, and high-level goals. These components can generate trajectories or control commands, optionally using reinforcement learned policies, optimization-based planners, or hybrid systems. Connections to backend services can permit off-board processing, fleet-level learning, or remote supervision where appropriate, while on-board components can maintain safe operation in the presence of network latency or failures.

The systems described herein can be implemented using centralized, decentralized, or hybrid arrangements. For instance, models may be deployed in cloud environments, on edge devices, or across both, depending on requirements such as latency, privacy, cost, and reliability. Load balancing and resource management components can distribute processing across devices or data centers and can provide elasticity to accommodate changing workloads.

Certain embodiments may expose functionality through application programming interfaces, software development kits, or graphical user interfaces. Client applications can submit requests to backend services, which can apply authentication, authorization, logging, and policy enforcement before invoking models or tools and returning results.

The systems and methods disclosed herein can be implemented in hardware, software, firmware, or any combination thereof. In some embodiments, operations are carried out by one or more processors executing program instructions stored on one or more non-transitory computer-readable media. Such media can include, without limitation, semiconductor memory, magnetic storage, optical storage, and combinations thereof. Program instructions, when executed by the processors, cause the processors to perform the operations described herein.

Instructions can be delivered to computing devices in various ways, such as pre-installation, physical distribution of media, or transmission over networks. Instructions received over a network can be stored in memory or persistent storage and then executed by one or more processors. Dedicated hardware logic, such as application-specific integrated circuits or field programmable gate arrays, can be used alone or in combination with software to implement certain functionality.

Any methods described in connection with embodiments of the present disclosure can be represented as one or more flow diagrams or state diagrams. Blocks in such diagrams can correspond to modules, components, operations, or code segments that implement the associated functionality. Blocks can be reordered, combined, executed concurrently, or omitted according to implementation-specific considerations, unless a particular ordering is required by the claims.

Examples and embodiments described herein illustrate, rather than limit, the claimed subject matter. Certain features have been described in connection with particular embodiments for clarity, but other embodiments can include such features in different combinations. Features described in separate embodiments can be combined, and features described in a single embodiment can be separated, unless such combinations or separations are inconsistent with the claims. The scope of the disclosure is defined by the claims and their equivalents.

### Overview:

The present disclosure describes innovative enhancements in sports video analytics and playback capabilities, offering a revolutionary approach to biomechanics analysis and user interaction. The system’s solution introduces dynamic playback navigation, immersive 3D visualizations, and seamless multi-camera synchronization, transforming how sports performance is analyzed and experienced.

Further, the present disclosure pertains to the fields of video processing, sports biomechanics, and metadata-driven playback systems, and further addresses challenges in seamless user navigation, immersive perspectives, and efficient integration of real-time analytics.

Further, in some embodiments, the disclosed system may incorporate an Enhanced Media Player, enabling an interactive, feature-rich playback experience by integrating the following functionalities.

1. One-Click Navigation to Key Moments: Utilize embedded activity and phase markers (e.g., "jump shot," "release phase") for instant navigation to critical events within a video.

2. Pre-Set Perspectives: Provide predefined camera angles such as:

Shooter's view

Top-down/hoop view

Defender's view

Side coach view

3. Visual and Performance Comparisons: Introduce ghosted overlays and side-by-side comparisons to visualize improvements or deviations, similar to shadow runners in fitness apps.

4. Seamless Integration with Advanced Metrics: Enable dynamic overlays for performance insights (e.g., speed, angles, timing) fetched via APIs.

1. Interactive Playback: Use embedded metadata for timeline navigation and dynamic overlays.

2. 3D and 6D Visualizations: Leverage Three.js and WebRTC to render immersive environments and real-time pose data.

3. Real-Time API Integration: Fetch additional metrics and data dynamically using API endpoints embedded in the metadata.

4. Multi-Camera Synchronization: Support simultaneous playback of raw feeds with adaptive bitrate control.

Further, in some embodiments, the present disclosure may describe the following use cases associated with the disclosed system.

1. For Athletes and Coaches:

Instant feedback on biomechanics and personalized insights for training improvement.

Compare current and past performances with ghosted overlays.

2. For Casual Users:

Easily share and engage with enhanced videos via browser-based playback.

Access system features with zero-download requirements.

Further, in some embodiments, the present disclosure may describe a system for embedding metadata into video streams to enable enhanced playback, including activity markers, pose data, and phase labels.

Further, in some embodiments, the present disclosure may describe a media player capable of dynamically interpreting metadata for interactive playback and immersive 3D visualizations.

Further, in some embodiments, the present disclosure may describe a method for synchronizing multi-camera views and providing pre-set perspectives for sports performance analysis.

Further, in some embodiments, the present disclosure may describe a framework for real-time API integration and subscription-gated feature unlocking.

In some embodiments, a core smart player concept that the present disclosure introduces is pluggable profiles that control what the player emphasizes during playback. Further, the "profile" may define:

Which heuristics/measurements are shown (and when).

How they are highlighted (e.g., overlays, callouts, timeline, markers).

Thresholds/bands (e.g., red/yellow/green) that vary by user segment (pre-teen vs adult), skill level training goal or coaching style.

Activity-specific emphasis (e.g., for a jump shot, focus on release timing + elbow alignment; for a pitch focus on stride timing + shoulder rotation).

In some embodiments, the present disclosure describes a key supplementary attribute data including a key moment marker data comprising a timestamp or timecode for a key moment in the physical activity. Further, the key moment marker data includes phase marker data identifying at least one phase of the activity and a corresponding time interval. Further, the disclosed method may include generating a time instance indicator data for a plurality of key moments and storing the time instance indicator data with the enhanced activity data. Further, the disclosure method may include receiving a jump-to command selecting a key moment or phase marker, and automatically repositioning the playback to the selected time instance.

In some embodiments, the present disclosure describes an enhanced activity data including a view orientation metadata defining one or more pre-set perspectives for viewing the activity. Further, the disclosed method may include receiving a view-switch command and switching among a plurality of pre-set perspectives while maintaining time alignment to the activity data. Further, at least one pre-set perspective comprises one of: a shooter view, a top-down/hoop view, a defender view, a side-coach view.

In some embodiments, the disclosed method may include rendering an immersive 3D environment that includes a reconstructed performer model and a virtual camera corresponding to a selected pre-set perspective. Further, the 3D model data is generated from multi-view inputs, depth estimation, or reconstruction models, and is time-aligned to the activity data.

Further, in some embodiments, the activity data includes two or more synchronized video feeds of the same activity instance. Further, the disclosed method may include aligning the two or more video feeds using timestamps, phase markers, pose alignment, or cross-correlation. Further, the playback controls (play/pause/scrub/jump-to) are applied simultaneously across the two or more video feeds. Further, a key moment marker is mapped to corresponding time instances across each of the two or more video feeds.

Further, in some embodiments, the overlaying includes rendering a ghosted overlay of a first phase juxtaposed with a second phase and rendering a side-by-side comparison of a current performance and a historical performance aligned by key moments.

Further, the enhanced activity data embeds an API endpoint identifier enabling retrieval of additional metrics during playback. Further, the retrieved metrics are rendered as synchronized overlays aligned to key moments.

Further, in some embodiments, the playback quality of one or more feeds is dynamically adapted based on bandwidth/latency/packet loss, and wherein overlays/3D rendering are scaled based on compute load.

Further, in some embodiments, one or more smart player features associated with the disclosed system are enabled based on an entitlement or subscription state, and wherein the enhanced activity data includes metadata indicating feature availability.

Further, the enhanced activity data is rendered according to a selected playback profile that specifies a set of heuristics, measurements, overlays, or key moment markers to be emphasized during playback. Further, the selected playback profile specifies one or more threshold bands for highlighting measurements, including a multi-level indicator comprising at least one of: red/yellow/green. Further, the playback profile is selected based on at least one of: athlete age group, skill level, training objective, injury/rehabilitation stage, sport type, or activity type. Further, the playback profile is provided as a pluggable configuration object and is loaded at runtime to control playback navigation and overlay rendering. Further, the playback profile is retrieved from a profile repository and identifies a creator, version, or compatibility metadata.

Further, in some embodiments, the supplementary feature data is generated using at least one of: 3D key points, quaternions, or derived rotational metrics.

In some embodiments, the present disclosure describes a non-transitory computer-readable medium storing one or more instructions which, when executed by a processing device of a computing device, causes the computing device to perform a method for facilitating metadata-driven interactive playback. Further, the method may include receiving one or more activity data from one or more devices. Further, the one or more activity data represent one or more contents associated with one or more physical activities. Further, the method may include obtaining a key supplementary attribute data based on the one or more activity data. Further, the key supplementary attribute data represents one or more key attributes supplementing the one or more contents. Further, the method may include processing each of the one or more activity data and the key supplementary attribute data. Further, the method may include generating one or more enhanced activity data based on the processing of each of the one or more activity data and the key supplementary attribute data. Further, the one or more enhanced activity data represent the one or more contents augmented with the one or more key attributes. Further, the method may include storing each of the one or more activity data and the one or more enhanced activity data. Further, the method may include transmitting the one or more enhanced activity data to the one or more devices.

In some embodiments, the present disclosure relates to systems and methods for provisioning enhanced activity data using metadata-driven transformations, artificial intelligence-based phase detection, and dynamic content embedding. The technology involves improvements in computer video processing, metadata generation frameworks, AI-driven biomechanical inference systems, and real-time interactive media delivery.

In some embodiments, the disclosed system may provide an inherent improvement to video analytics systems by enabling a processing device to determine a key activity phase based on AI models that may analyze temporal, spatial, and biomechanical markers within an activity data stream, addressing the technical problem that conventional video playback platforms lack automated identification of salient moments in an activity sequence, leading to inefficient manual review. The improvement may include techniques wherein an AI module may classify phases such as a shot phase, release phase, acceleration phase, or transition phase using temporal convolutional networks, transformer-based sequence models, or recurrent neural networks that may learn temporal dependencies. In some embodiments, the system may improve the accuracy of phase detection by integrating pose estimation data, velocity vectors extracted via optical flow, and multi-view synchronization signals, thereby improving the underlying technology of automated video classification.

In some embodiments, the disclosed system may enhance the underlying technology of metadata-driven video enhancement by generating a characteristic metadata for a key activity phase. The technical problem addressed may involve conventional systems failing to encode fine-grained metadata that corresponds to biomechanical features, temporal markers, or spatial references. The system may implement the given feature by computing a metadata structure that may include key timestamps, angular displacement measurements, joint position vectors, or depth-modeling attributes. The given metadata may be dynamically embedded into the activity data for real-time retrieval during playback. In one example, the metadata may include a normalized skeletal representation derived using pose estimation frameworks, whereas in another example, the metadata may include a semantic label representing an event such as “ball release,” “maximum extension,” or “impact phase”, improving technologies related to metadata encoding and real-time interactive playback engines.

In some embodiments, the disclosed system may improve video comparison technologies by generating a transition data that may model changes between a first activity phase and a second activity phase. The technical problem addressed may involve the inability of conventional systems to provide smooth, computer-generated comparisons between sequential biomechanical movements. The system may perform the said function by computing differential feature maps, variance vectors, or interpolation models that quantify differences in body alignment, object trajectory, or spatial orientation. In certain implementations, the transition data may include a ghosted overlay that may visualize the juxtaposition between two moments in time, enhancing technologies related to biomechanical visualization, temporal morphing, and video augmentation.

In some embodiments, the disclosed system may improve the accuracy of interactive media navigation systems by generating time instance indicators associated with each key activity phase. The technical problem addressed may involve inaccurate scrubbing or inefficient navigation through performance videos in conventional platforms. The processing device may compute such indicators using techniques such as cross-correlation between sensor-derived timestamps, dynamic time-warping alignment across multiple video streams, or probabilistic time inference based on fluctuating pose stability metrics, improving the technology of timeline indexing and interactive playback control systems.

In some embodiments, the disclosed system may provide an improvement to perspective-rendering engines by generating an activity viewing orientation metadata. The technical problem addressed relates to the rigidity of traditional video playback systems that do not allow dynamic switching among multiple viewpoint perspectives. By generating metadata describing a shooter’s view, top-down view, defensive angle, or side-coach view, the system may dynamically re-render the scene by extracting depth cues, pose vectors, and virtual camera positions derived from AI-based 3D reconstruction, improving virtual camera synthesis technology, multi-perspective video playback technology, and real-time scene reconstruction systems.

In some embodiments, the disclosed system may enhance biomechanical analytics by generating insight data such as speed, angle, or timing based on performance attributes detected from the activity data. The technical problem addressed may involve the lack of automated analytics in conventional sports analysis tools. The insight data may be computed using techniques such as regression-based motion modeling, neural-network–based angle detection, or reinforcement learning models that infer optimal motion pathways, improving motion analytics technology and real-time sports performance inference systems.

In some embodiments, the disclosed system may improve real-time rendering technology by generating a 3D model data representing an object or performer. The technical problem involves the inability of conventional systems to derive accurate 3D structures from 2D media. The processing device may use depth estimation models, multi-view stereo reconstruction, or neural radiance fields to create a 3D representation, enabling real-time rendering frameworks such as three.js, unity, or unreal engine to display reconstructed biomechanical performance models. The improvement advances the field of 3D modeling and reconstruction from video.

In some embodiments, the disclosed system may provide an improvement in API-based data retrieval systems by embedding an API endpoint data into the enhanced activity data. The technical problem addressed relates to the fragmented nature of retrieving external analytics, which usually requires separate application-level requests. By embedding API endpoint data directly into the activity data, the system may dynamically retrieve external metrics during playback without additional architectural complexity, improving real-time data-fetching technology and integrated analytics retrieval frameworks.

In some embodiments, the disclosed system may improve overlay-based analytical visualization systems by associating insight data with characteristic metadata and embedding it into the enhanced activity data. The technical problem addressed involves the inability to merge real-time performance metrics with video playback in a synchronized manner. The system may implement alignment techniques that bind metadata timestamps to measured performance attributes, enabling synchronized overlays such as trajectory arcs, angular indicators, or timing-based annotations, improving synchronized data-to-video overlay technologies.

In some embodiments, an additional technical improvement may include implementing a predictive performance modeling module that may generate predicted biomechanical states at future time intervals using historical activity data. The technical problem addressed involves the inability of systems to forecast athletic motions. The system may use sequence-based generative models such as transformer decoders or LSTM-based predictive engines. For example, the system may generate predicted joint angles for the next 0.5 seconds to assist in coaching scenarios, improving the technology of predictive biomechanics and proactive motion analysis.

In some embodiments, the disclosed system may include an adaptive bitrate enhancement engine that may dynamically adjust the quality of enhanced activity data based on computational load and bandwidth variability. The technical problem addressed involves disruptions in interactive playback when real-time overlays are rendered. The system may implement network-aware quality scaling using reinforcement learning models that select optimal bitrate levels, improving streaming technology and adaptive quality control engines.

In some embodiments, the disclosed system may include an anomaly detection feature that may automatically detect deviations from biomechanical norms using clustering algorithms or neural auto encoders. The technical problem addressed relates to the inability of current systems to identify subtle performance flaws. The system may determine anomalies in joint articulation speed, unstable trajectories, or inconsistent timing rhythms, improving anomaly detection technology in biomechanical systems.

In some embodiments, the disclosed system may include a personalized metadata profiling engine that may generate user-specific metadata templates based on historical performance. The technical problem addressed involves generic metadata structures that do not adapt to individual biomechanics. The system may perform clustering, feature extraction, or adaptive normalization to create metadata profiles tailored for each user, improving metadata personalization technology and custom video analytics frameworks.

In some embodiments, the disclosed system may include an immersive mixed-reality playback mode wherein the enhanced activity data may be projected into a 3D space using AR or VR devices. The technical problem solved relates to traditional playback systems being restricted to 2D screens. The system may compute spatial anchors, depth alignment cues, and coordinate transformations for rendering enhanced activity sequences inside a mixed reality environment, improving mixed-reality visualization technology and interactive playback engines.

Further, in some embodiments, the coach device may include a communication subsystem comprising one or more network interfaces, a processing device comprising one or more processors, a memory storing instructions, a storage device, and a coach-side presentation device comprising at least one of a display device or an audio output device. Further, in some embodiments, the coach-side processing device may execute a plurality of software modules including a segment request scheduler, a throughput estimator, a buffer manager, a decoder pipeline, a synchronization controller, and a clip generator/remuxer. Further, these modules may be implemented as software instructions executed by the processing device, optionally with hardware acceleration for decoding and timestamp processing.

Further, in some embodiments, each media feed of the plurality of media feeds may comprise an encoded audiovisual stream segmented into a plurality of segments, wherein each segment represents a contiguous time interval of media samples. Further, a segment may have a segment identifier and may be associated with a start presentation timestamp and an end presentation timestamp. Further, aligned segment boundaries may refer to segment boundary times where at least two media feeds have segments whose start presentation timestamps match within a tolerance or match according to a common timeline reference. Further, bitrate representations may refer to alternative encoded versions of a given media feed, each represented by a segment list in a manifest. Further, the manifest may be an HLS manifest, a DASH manifest, or any manifest format that identifies segment locations and representation characteristics. Further, the at least one network performance parameter may include at least one of effective throughput, segment download time, round-trip time, packet loss, jitter, or buffer occupancy. Further, the coach-side processing device may compute effective throughput for a segment as a segment size divided by a segment download time, and may compute buffer occupancy as a difference between a latest buffered presentation timestamp and a current playback timestamp.

Further, in some embodiments, the at least one enhanced activity data may include media feed data and a timed-metadata track carrying the key supplementary attribute data mapped to presentation timestamps. Further, the timed-metadata track may be carried using timed text or metadata containers such that each metadata item includes a timestamp and an attribute payload. Further, event markers may be represented as metadata items including at least an event type identifier, an event timestamp, and an event value. Further, in some embodiments, threshold values including at least one of a loss threshold, a drift threshold, an A/V threshold, or an offset threshold may be configurable parameters stored in memory, and may be set to ranges including packet loss threshold values of 1–10%, drift threshold values of 20–200 ms, A/V threshold values of 40–250 ms, and offset threshold values of 20–150 ms, such that the threshold values provide objective boundaries while permitting implementation-specific tuning.

Further, the present disclosure describes a method for facilitating metadata-driven interactive playback.

Further, in some embodiments, the method may include establishing, using the coach-side processing device, a first network path via a first network interface of the coach device and a second network path via a second network interface of the coach device, wherein the first network interface and the second network interface comprise distinct physical or logical interfaces. Further, the method may include monitoring, using the coach-side processing device, the at least one network performance parameter for each of the first network path and the second network path during the simultaneous playback, wherein monitoring comprises timestamping segment requests and responses to compute at least one of segment download time, effective throughput, and round-trip time per path. Further, the method may include determining, using the coach-side processing device, a segment request allocation that assigns requests for segments of the plurality of media feeds across the first network path and the second network path based on the monitoring. Further, determining the segment request allocation may include computing, for each network path, a path score as a function of measured throughput and packet loss, and assigning segments to network paths proportionally to the path scores. Further, the method may include requesting, using the coach-side processing device, a first set of segments over the first network path and a second set of segments over the second network path based on the segment request allocation. Further, adapting the simultaneous playback may include maintaining a segment buffer keyed by segment identifiers and inserting received segments into the segment buffer irrespective of arrival order, and decoding the first set of segments and the second set of segments as a continuous decode sequence by reading from the segment buffer in segment identifier order or in presentation timestamp order.

Further, in some embodiments, the method may include detecting, using the coach-side processing device, a missing segment during the simultaneous playback based on a discontinuity in a sequence of segment identifiers, wherein detecting comprises determining that an expected segment identifier is not present in the segment buffer when a subsequent segment identifier has been received or when a playback deadline is approaching. Further, the method may include determining, using the coach-side processing device, that the missing segment is associated with a network path having a packet loss value exceeding a loss threshold based on the monitoring of the at least one network performance parameter, wherein the packet loss value is computed from request/acknowledgment failures or transport-layer statistics for the network path. Further, the method may include requesting, using the coach-side processing device, a retransmission of the missing segment over an alternate network path different from the network path, wherein requesting comprises issuing a segment retrieval transaction via the alternate network interface. Further, the method may include verifying, using the coach-side processing device, an integrity value for the retransmitted missing segment, wherein the integrity value comprises at least one of a checksum, a hash, or a message authentication code provided in the manifest or provided by a segment header. Further, the method may include inserting, using the coach-side processing device, the retransmitted missing segment into the segment buffer based on the segment identifier, wherein adapting the simultaneous playback comprises decoding from the segment buffer without triggering a rebuffering event by ensuring the retransmitted missing segment is inserted before a playback deadline associated with the start presentation timestamp of the missing segment.

Further, in some embodiments, the method may include determining, using the coach-side processing device, a short-window throughput estimate and a long-window throughput estimate based on segment download times measured during the monitoring of the at least one network performance parameter, wherein the short-window throughput estimate is computed over a first number of most recent segments and the long-window throughput estimate is computed over a second number of most recent segments larger than the first number. Further, the method may include generating, using the coach-side processing device, a composite throughput estimate based on a weighted combination of the short-window throughput estimate and the long-window throughput estimate. Further, the method may include selecting, using the coach-side processing device, a candidate bitrate representation based on the composite throughput estimate and a safety factor, wherein the safety factor reduces aggressiveness of selection to preserve buffer occupancy. Further, the method may include determining, using the coach-side processing device, whether a hysteresis condition is satisfied for switching to the candidate bitrate representation, wherein the hysteresis condition includes requiring the composite throughput estimate to satisfy an upswitch threshold for a first number of consecutive segments and permitting a downswitch when the composite throughput estimate falls below a downswitch threshold for a second number of segments. Further, the method may include switching, using the coach-side processing device, to the candidate bitrate representation only upon determining that the hysteresis condition is satisfied, wherein adapting the simultaneous playback comprises switching at an aligned segment boundary by selecting a next segment from the candidate bitrate representation having a start presentation timestamp matching a segment boundary time of a currently playing representation.

Further, in some embodiments, the method may include extracting, using the coach-side processing device, presentation timestamps for audio frames and video frames for each of at least two of the plurality of media feeds during the simultaneous playback, wherein the presentation timestamps are read from container headers or derived from decoder output timestamps. Further, the method may include selecting, using the coach-side processing device, a master clock corresponding to an audio timeline of a master media feed of the at least two media feeds, wherein selecting the master clock comprises selecting the audio timeline having at least one of lowest measured jitter, greatest buffer occupancy, or a user-selected primary feed indicator. Further, the method may include determining, using the coach-side processing device, a timestamp drift value for a non-master media feed relative to the master clock, wherein the timestamp drift value is computed as a difference between a non-master audio presentation timestamp at a reference point and a master clock timestamp at the reference point. Further, the method may include determining, using the coach-side processing device, that the timestamp drift value exceeds a drift threshold. Further, the method may include adjusting, using the coach-side processing device, an audio playback timeline of the non-master media feed using bounded time-scale modification while preserving pitch, wherein bounded time-scale modification includes applying a time-scaling algorithm to produce a playback-rate adjustment within a bounded rate range while preserving pitch. Further, adapting the simultaneous playback may include aligning video presentation of the non-master media feed to the adjusted audio playback timeline at a subsequent segment boundary.

Further, in some embodiments, the method may include sampling, using the coach-side processing device, a synchronization offset between the at least two of the plurality of media feeds at a plurality of times during the simultaneous playback, wherein the synchronization offset is computed as a difference between corresponding presentation timestamps for the at least two media feeds at a common sampling instant. Further, the method may include filtering, using the coach-side processing device, the synchronization offset to generate a filtered offset, wherein filtering includes applying an exponential moving average or low-pass filter. Further, the method may include determining, using the coach-side processing device, a correction command based on the filtered offset using a proportional-integral control process, wherein determining includes computing a control value from a proportional component and an integral component and limiting the control value to a bounded range. Further, the method may include applying, using the coach-side processing device, the correction command by adjusting a playback rate of one of the at least two media feeds within a bounded rate range. Further, the method may include restoring, using the coach-side processing device, the playback rate to a nominal playback rate after determining that the synchronization offset remains below an offset threshold for a dwell period.

Further, in some embodiments, the method may include determining, using the coach-side processing device, an audio-video offset for at least one of the plurality of media feeds based on presentation timestamps, wherein the audio-video offset is computed as a difference between an audio presentation timestamp and a corresponding video presentation timestamp for the at least one media feed. Further, the method may include determining, using the coach-side processing device, that the audio-video offset exceeds an A/V threshold. Further, the method may include selecting, using the coach-side processing device, a resynchronization segment boundary time for the at least one media feed, wherein the resynchronization segment boundary time corresponds to a segment boundary or a keyframe boundary. Further, the method may include requesting, using the coach-side processing device, a next segment of a selected bitrate representation, wherein the next segment has a start presentation timestamp equal to the resynchronization segment boundary time. Further, the method may include flushing, using the coach-side processing device, frames from a decode buffer that have presentation timestamps inconsistent with the resynchronization segment boundary time, wherein flushing comprises removing audio frames and/or video frames whose timestamps precede the resynchronization segment boundary time by more than a tolerance. Further, adapting the simultaneous playback may include resuming decoding at the resynchronization segment boundary time by decoding the requested next segment and continuing playback under the selected bitrate representation.

Further, in some embodiments, the method may include receiving, using the coach-side processing device, a timed-metadata track comprised in the at least one enhanced activity data, wherein the timed-metadata track carries the key supplementary attribute data mapped to presentation timestamps of at least one of the plurality of media feeds. Further, the method may include detecting, using the coach-side processing device, an event marker in the timed-metadata track based on an event criterion, wherein the event criterion includes at least one of an attribute value crossing a threshold, an attribute pattern occurring within a time window, or a specified event type identifier. Further, the method may include determining, using the coach-side processing device, a clip start time and a clip end time based on the event marker and a pre-event window and a post-event window, wherein the pre-event window and post-event window are stored parameters. Further, the method may include requesting, using the coach-side processing device, for each of at least two of the plurality of media feeds, a set of segments having presentation timestamps spanning the clip start time to the clip end time, wherein requesting includes mapping the clip start time and the clip end time to segment identifiers using a segment index derived from the manifest. Further, the method may include generating, using the coach-side processing device, a clip package by remuxing the requested set of segments into a clip container while preserving synchronization metadata across the at least two media feeds, wherein remuxing includes copying encoded samples into a new container and writing updated timing headers such that a clip timeline begins at a normalized start while maintaining relative offsets between tracks for synchronized playback. Further, the clip package may include a portion of the timed-metadata track corresponding to the clip start time to the clip end time such that the key supplementary attribute data remains aligned to the clip timeline.

Further, in some embodiments, the method may include generating, using the coach-side processing device, a clip manifest that identifies, for each of at least two of the plurality of media feeds, a corresponding sequence of segment identifiers spanning the clip start time to the clip end time, wherein the clip manifest includes, for each media feed, a feed identifier, an ordered list of segment identifiers, and timing information indicating a mapping between the segment identifiers and presentation timestamps. Further, the method may include validating, using the coach-side processing device, that retrieved segments for each of the at least two media feeds include presentation timestamps referenced to a common clip timeline, wherein the common clip timeline is derived from a selected reference feed or a shared clock reference embedded in the at least one enhanced activity data. Further, the method may include assembling, using the coach-side processing device, a synchronized multi-feed clip based on the clip manifest by concatenating segments in the identified order and aligning track start times to the common clip timeline. Further, a maximum inter-feed timestamp offset of the synchronized multi-feed clip may be less than an offset threshold, wherein the coach-side processing device enforces the offset threshold by trimming initial samples, inserting initial padding, or adjusting an initial timeline offset recorded in the clip container.

Further, in some embodiments, the method may include training, using the coach-side processing device, an artificial neural network (ANN) using training examples derived from historical timed-metadata tracks and corresponding event labels to generate a trained ANN, wherein training examples comprise sequences of key supplementary attribute data values aligned to presentation timestamps and event labels indicating whether a time interval corresponds to a highlight. Further, training may include executing backpropagation and gradient-based optimization over a stored training set until a stopping criterion is met, and storing trained ANN parameters in memory. Further, the method may include applying, using the coach-side processing device, the trained ANN to the timed-metadata track comprised in the at least one enhanced activity data to detect at least one candidate highlight event, wherein applying includes inputting a time-windowed feature vector derived from the timed-metadata track and receiving a confidence score output by the trained ANN. Further, the method may include determining, using the coach-side processing device, that the at least one candidate highlight event satisfies a confidence threshold. Further, the method may include determining, using the coach-side processing device, a clip start time and a clip end time for the at least one candidate highlight event based on the timed-metadata track, including applying a pre-event window and a post-event window. Further, the method may include generating, using the coach-side processing device, a synchronized multi-feed clip spanning the clip start time to the clip end time for playback on the coach-side presentation device, including requesting and remuxing segments for each of the at least two media feeds while preserving synchronization metadata across the at least two media feeds.

Further, in some embodiments, the method may include training, using the coach-side processing device, a predictive model using sequences of monitored network performance parameters to generate a trained predictive model, wherein the monitored network performance parameters include time-ordered measurements of at least one of throughput, download time, round-trip time, packet loss, and buffer occupancy. Further, the predictive model may comprise a regression model or a neural network model that outputs a predicted near-term available throughput for a forecast horizon. Further, the method may include predicting, using the coach-side processing device, a near-term available throughput by inputting current monitored network performance parameters to the trained predictive model. Further, the method may include determining, using the coach-side processing device, that the near-term available throughput is below a throughput threshold, wherein the throughput threshold corresponds to a bitrate budget required to maintain the simultaneous playback for the at least two media feeds at current bitrate representations plus a safety margin. Further, the method may include selecting, using the coach-side processing device, reduced preferred bitrate representations for the at least two of the plurality of media feeds based on the determining, including selecting bitrate representations whose combined bitrates are less than the predicted near-term available throughput multiplied by a safety factor. Further, the method may include prefetching, using the coach-side processing device, at least one next segment for each of the at least two media feeds into a playback buffer based on the reduced preferred bitrate representations, wherein prefetching includes issuing segment requests ahead of playback deadlines to maintain buffer occupancy above a minimum buffer threshold. Further, adapting the simultaneous playback may include decoding from the playback buffer under the reduced preferred bitrate representations.

Further, in some embodiments, each media feed of the plurality of media feeds may comprise an encoded audiovisual stream segmented into a plurality of segments, wherein each segment represents a contiguous time interval of media samples. Further, a segment may have a segment identifier (e.g., monotonically increasing integer, sequence number, or URI-derived identifier) and may be associated with a start presentation timestamp and an end presentation timestamp. Further, aligned segment boundaries may refer to segment boundary times where at least two media feeds have segments whose start presentation timestamps match within a tolerance (e.g., ≤50 ms) or match exactly according to a common timeline reference.

Further, in some embodiments, bitrate representations may refer to alternative encoded versions of a given media feed (e.g., 240p/360p/720p, or differing bitrates), each represented by a segment list in a manifest. Further, the manifest may be an HLS or DASH manifest, or any manifest format that identifies segment locations and representation characteristics. Further, the at least one network performance parameter may include at least one of: effective throughput (bytes/time), segment download time, round-trip time, packet loss, jitter, or buffer occupancy (in seconds). Further, the coach-side processing device may compute effective throughput for a segment as segment_size_bytes / download_time_seconds, and may compute buffer occupancy as a difference between (i) a latest buffered presentation timestamp and (ii) a current playback timestamp.

Further, in some embodiments, the at least one enhanced activity data may include (i) media feed data and (ii) a timed-metadata track carrying the key supplementary attribute data mapped to presentation timestamps. Further, the timed-metadata track may be carried using timed text or metadata containers (e.g., ID3 tags, emsg events, WebVTT cues, or ISO-BMFF metadata boxes) such that each metadata item includes a timestamp and an attribute payload. Further, event markers may be represented as metadata items including at least an event type identifier, an event timestamp, and an event value.

Further, in some embodiments, threshold values (e.g., loss threshold, drift threshold, A/V threshold) may be configurable parameters stored in memory, and may be set to example ranges such as: packet loss threshold 1–10%, drift threshold 20–200 ms, A/V threshold 40–250 ms, and offset threshold 20–150 ms. Further, such numeric examples provide objective boundaries while permitting implementation-specific tuning.

Further, in some embodiments, the operations described herein improve operation of networked playback systems by reducing rebuffer events, reducing oscillation in representation switching, maintaining cross-feed synchronization, and enabling efficient event-based navigation and clip creation using timestamped metadata synchronized to the media timeline. Further, these improvements are rooted in segment scheduling, buffer control, timestamp alignment, and remuxing operations performed by the coach-side processing device.

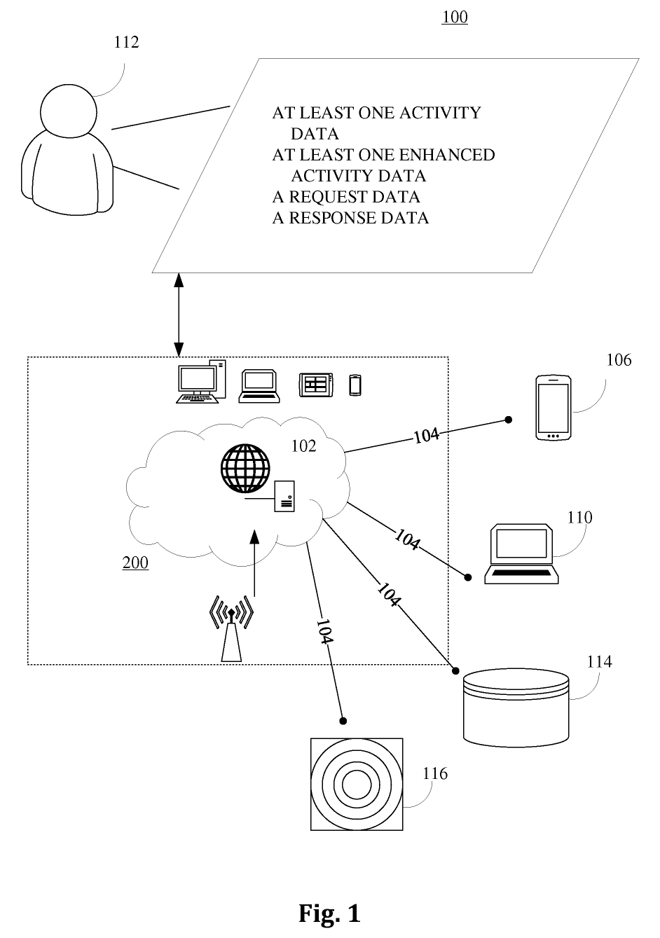

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

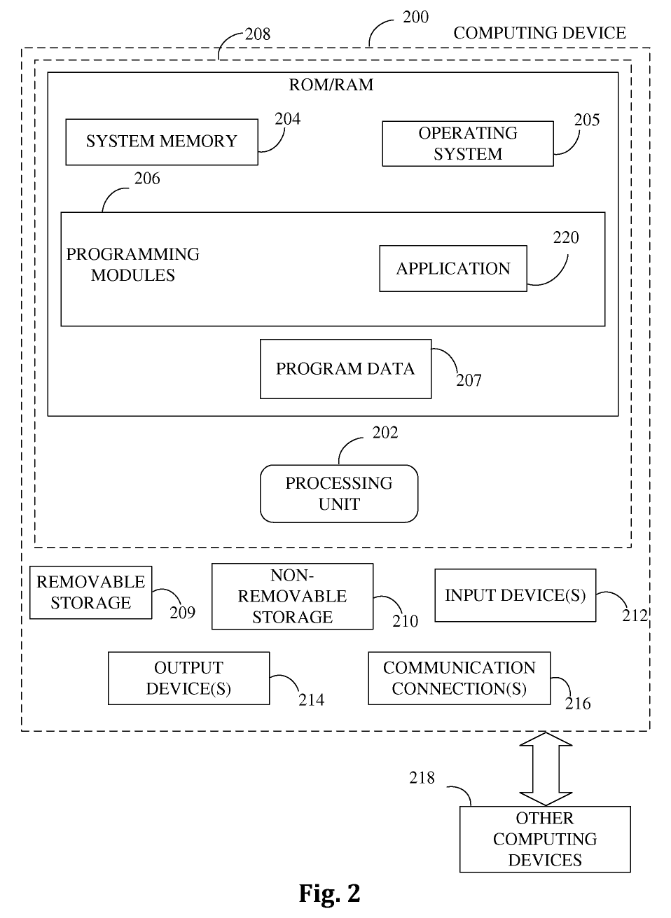

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200’s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods’ stages may be modified in any manner, including by reordering stages and/or inserting or deleting stages, without departing from the disclosure.

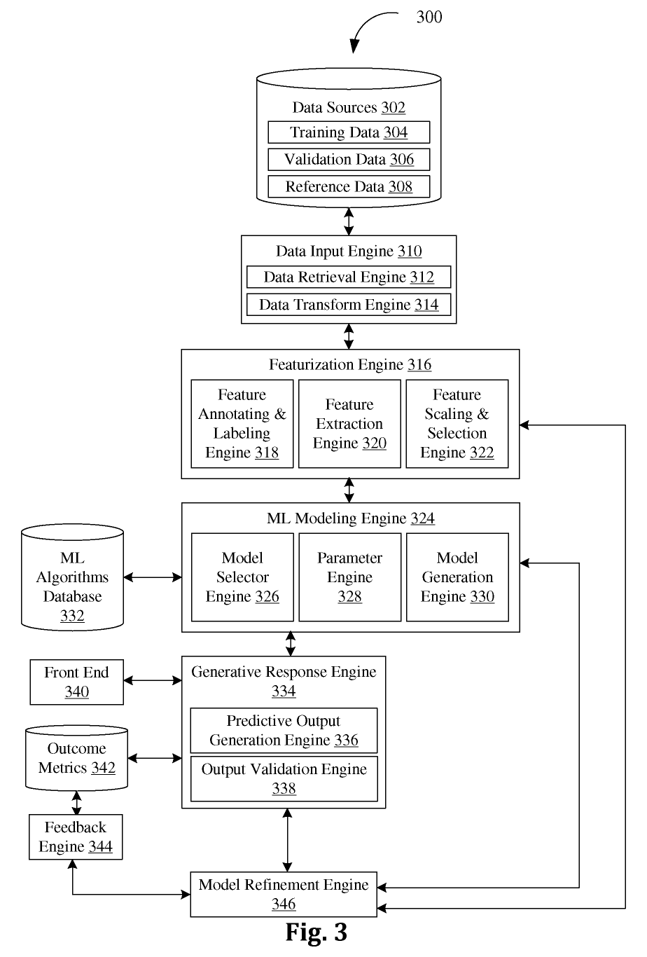

FIG. 3 is a block diagram illustrating a machine-learning system 300 for implementing various embodiments of this disclosure, in accordance with some embodiments. Although the disclosed machine-learning system 300 depicts particular system components and an arrangement of such components, the given depiction is to facilitate a discussion of the present technology and should not be considered limiting unless specified in the appended claims. For, example some components that are illustrated as separate, may be combined with other components and some components may be divided into separate components.

Accordingly, the machine-learning system 300 may include a plurality of interrelated modules and engines configured to implement a machine‑learning pipeline. Further, the machine-learning system 300 may include a data sources module 302 that is made up of a training data repository 304, a validation data repository 306, and a reference data repository 308, each repository being configured to store respective classes of input records and reference information. Further, the machine-learning system 300 may include a data input engine 310 configured to receive data from the data sources module 302. Further, the data input engine 310 may include a data retrieval engine 312 configured to access and ingest data from the repositories (304, 306, 308), and a data transform engine 314 configured to perform initial normalization, parsing and format conversion on the ingested data. Further, the machine-learning system 300 may include a featurization engine 316 configured to prepare temporal and predictive representations of transformed data. Further, the featurization engine 316 may include a feature annotating & labeling engine 318 for applying labels and annotations to data instances, a feature extraction engine 320 for deriving feature vectors and candidate predictors, and a feature scaling & selection engine 322 for performing numerical scaling, dimensionality reduction and selection of salient features. Further, the machine-learning system 300 may include a machine learning (ML) modeling engine 324 configured to construct predictive models from selected features. Further, the ML modeling engine 324 may include a model selector engine 326 for selecting among candidate model classes, a parameter engine 328 for determining and tuning hyper parameters, and a model generation engine 330 for instantiating and training model artifacts according to selected architectures and parameters. Further, the machine-learning system 300 may include an ML algorithms database 332 configured to store algorithmic implementations, model templates and associated metadata and to be accessible by components of the ML modeling engine 324. Further, the machine-learning system 300 may include a generative response engine 334 configured to produce user‑facing outputs based on the trained models. Further, the generative response engine 334 may include a predictive output generation engine 336 for generating predictions or synthesized responses and an output validation engine 338 for verifying, filtering and validating generated outputs against predefined criteria and reference data. Further, the machine-learning system 300 may include a front end 340 configured to present validated outputs to end users and to collect interaction signals. Further, the machine-learning system 300 may include an outcome metrics module 342 configured to compute performance measures, accuracy statistics and other evaluation metrics derived from model outputs and user interactions. Further, the machine-learning system 300 may include a feedback engine 344 configured to aggregate outcome metrics and user feedback and to format such information for reuse. Further, the machine-learning system 300 may include a model refinement engine 346 configured to receive feedback from the feedback engine 344 and the outcome metrics module 342, and to effect iterative updates to the ML modeling engine 324 and to the ML algorithms database 332. Further, the components are communicatively coupled so that data and control signals are exchanged among the repositories (304, 306, 308), the data input engine 310, the featurization engine 316, the ML modeling engine 324 (with algorithmic support from the ML algorithms database 332), the generative response engine 334 and the front end 340 for output generation. Further, the outcome metrics 342 and feedback engine 344 provide closed‑loop signals to the model refinement engine 346 to enable retraining, parameter adjustment and algorithm selection, thereby enabling cooperative execution of data acquisition, feature engineering, model construction, output generation, validation, evaluation and iterative refinement within the disclosed machine‑learning system 300.

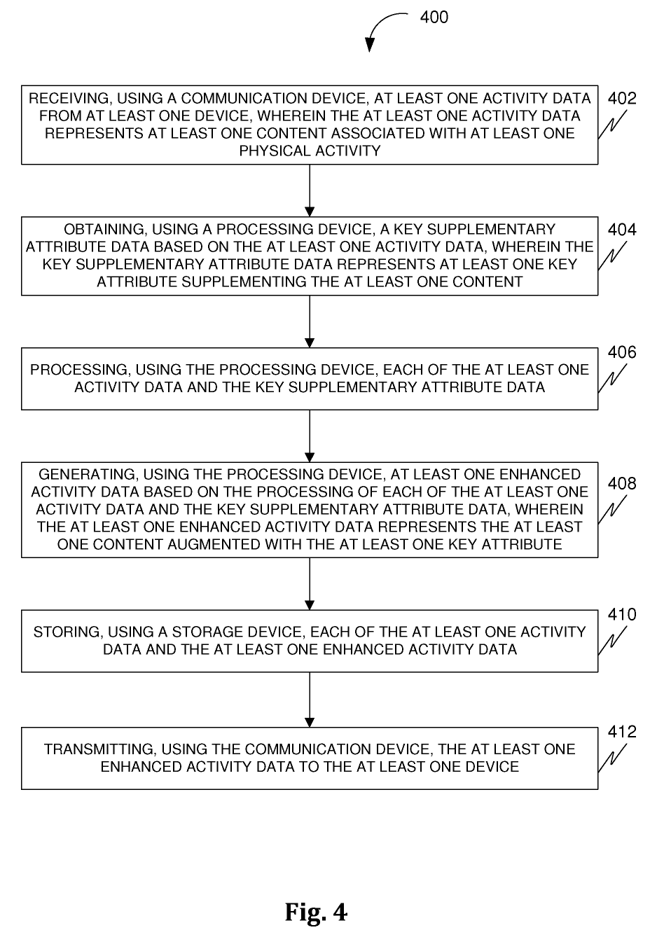

FIG. 4 illustrates a flowchart of a method 400 for facilitating metadata-driven interactive playback, in accordance with some embodiments. Accordingly, the method 400 may include a step 402 of receiving, using a communication device 902, one or more activity data from one or more devices 908. Further, the one or more activity data represent one or more contents associated with one or more physical activities. Further, the method 400 may include a step 404 of obtaining, using a processing device 904, a key supplementary attribute data based on the one or more activity data. Further, the key supplementary attribute data represents one or more key attributes supplementing the one or more contents. Further, the method 400 may include a step 406 of processing, using the processing device 904, each of the one or more activity data and the key supplementary attribute data. Further, the method 400 may include a step 408 of generating, using the processing device 904, one or more enhanced activity data based on the processing of each of the one or more activity data and the key supplementary attribute data. Further, the one or more enhanced activity data represent the one or more contents augmented with the one or more key attributes. Further, the method 400 may include a step 410 of storing, using a storage device 906, each of the one or more activity data and the one or more enhanced activity data. Further, the method 400 may include a step 412 of transmitting, using the communication device 902, the one or more enhanced activity data to the one or more devices 908.

In some embodiments, the one or more enhanced activity data includes one or more attribute-embedded activity data. Further, the processing of each of the one or more activity data and the key supplementary attribute data includes embedding the one or more contents with the one or more key attributes. Further, the generating of the one or more enhanced activity data includes generating of the one or more attribute-embedded activity data based on the embedding of the one or more contents with the one or more key attributes.

In some embodiments, the one or more physical activities may be associated with one or more entities. Further, the one or more key attributes include one or more performance parameters 1302 associated with the one or more entities relative to the one or more physical activities. Further, the processing of each of the one or more activity data and the key supplementary attribute data includes overlaying the one or more performance parameters 1302 onto the one or more contents associated with the one or more physical activities. Further, the generating of the one or more enhanced activity data may be further based on the overlaying.

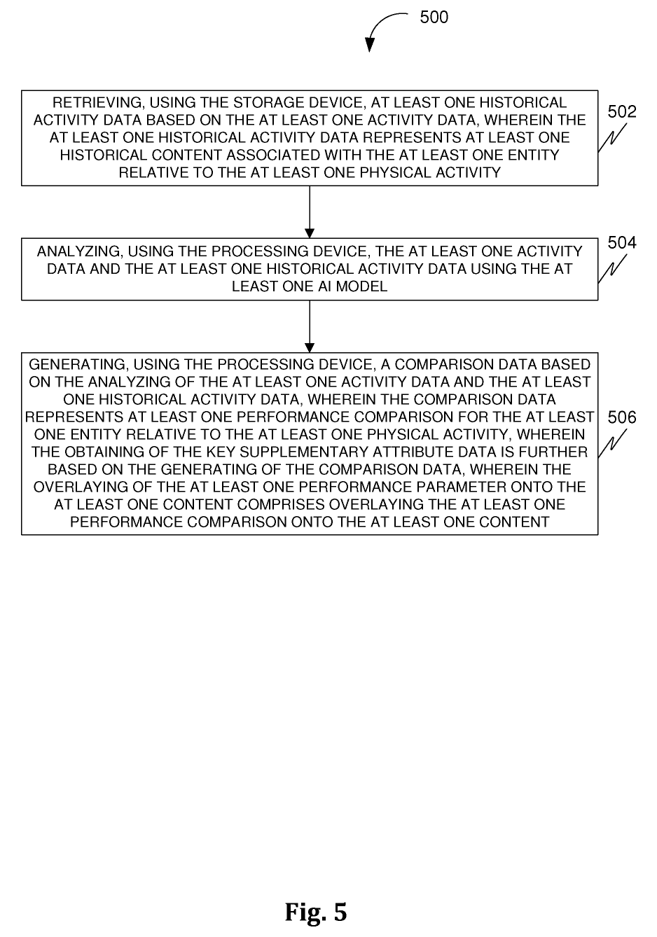

FIG. 5 illustrates a flowchart of a method 500 for facilitating metadata-driven interactive playback including generating, using the processing device 904, a comparison data, in accordance with some embodiments. Further, in some embodiments, the method 500 further may include a step 502 of retrieving, using the storage device 906, one or more historical activity data based on the one or more activity data. Further, the one or more historical activity data represent one or more historical contents associated with the one or more entities relative to the one or more physical activities. Further, in some embodiments, the method 500 further may include a step 504 of analyzing, using the processing device 904, the one or more activity data and the one or more historical activity data using the one or more AI models. Further, in some embodiments, the method 500 further may include a step 506 of generating, using the processing device 904, a comparison data based on the analyzing of the one or more activity data and the one or more historical activity data. Further, the comparison data represents one or more performance comparisons for the one or more entities relative to the one or more physical activities. Further, the obtaining of the key supplementary attribute data may be further based on the generating of the comparison data. Further, the overlaying of the one or more performance parameters 1302 onto the one or more contents includes overlaying the one or more performance comparisons onto the one or more contents.

In some embodiments, the one or more activity data includes a first activity phase data representing a first activity phase associated with a first time period and a second activity phase data representing a second activity phase associated with a second time period. Further, the second time period occurs later than the first time period. Further, the method 400 further includes generating, using the processing device 904, a transition data based on the first activity phase data and the second activity phase data. Further, the transition data represents a transition between the first activity phase and the second activity phase. Further, the obtaining of the key supplementary attribute data may be further based on the generating of the transition data. Further, the overlaying of the one or more performance parameters 1302 onto the one or more contents includes overlaying the transition data onto the one or more contents.

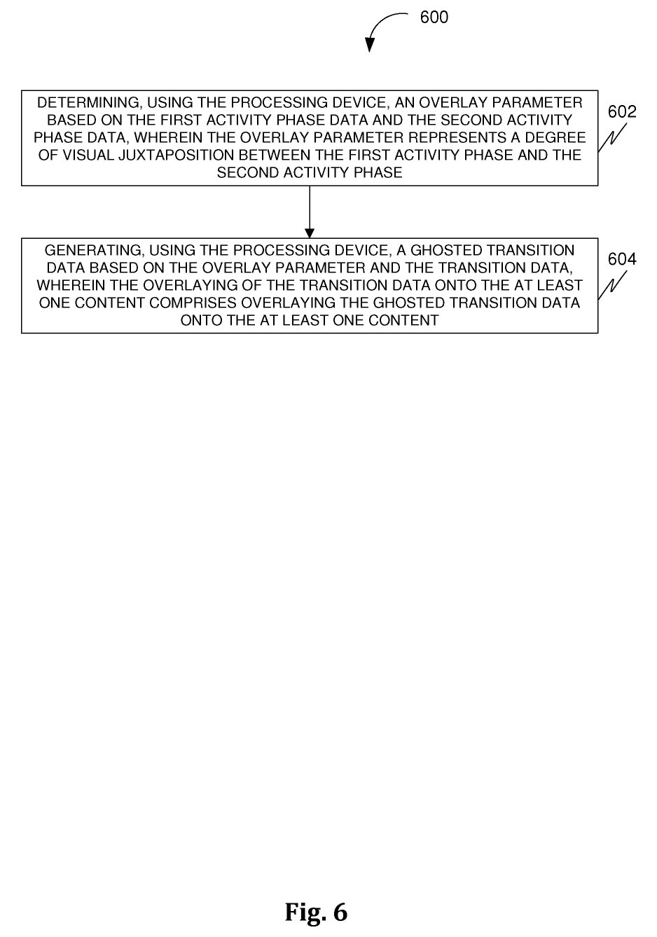

FIG. 6 illustrates a flowchart of a method 600 for facilitating metadata-driven interactive playback including generating, using the processing device 904, a ghosted transition data, in accordance with some embodiments. Further, in some embodiments, the method 600 further may include a step 602 of determining, using the processing device 904, an overlay parameter based on the first activity phase data and the second activity phase data. Further, the overlay parameter represents a degree of visual juxtaposition between the first activity phase and the second activity phase. Further, in some embodiments, the method 600 further may include a step 604 of generating, using the processing device 904, a ghosted transition data based on the overlay parameter and the transition data. Further, the overlaying of the transition data onto the one or more contents includes overlaying the ghosted transition data onto the one or more contents.

In some embodiments, the key supplementary attribute data includes an activity viewing orientation data representing one or more orientations 1304 for viewing the one or more physical activities.

Further, in some embodiments, the one or more devices 908 may include a coach device 1002 associated with one or more coaches. Further, the one or more enhanced activity data may include a media feed data representing two or more media feeds. Further, each of the two or more media feeds may be configured to be encoded in two or more bitrate representations. Further, the coach device 1002 may include a coach-side presentation device that may be configured for facilitating a simultaneous playback of at least two of the two or more media feeds. Further, the coach device 1002 may include a coach-side processing device that may be configured for monitoring one or more network performance parameters during the simultaneous playback. Further, the coach-side processing device may be configured for identifying a preferred bitrate representation for each of the two or more media feeds based on the monitoring of the one or more network performance parameters. Further, the coach-side processing device may be configured for adapting the simultaneous playback of the at least two of the two or more media feeds to the preferred bitrate representation based on the identifying of the preferred bitrate representation.

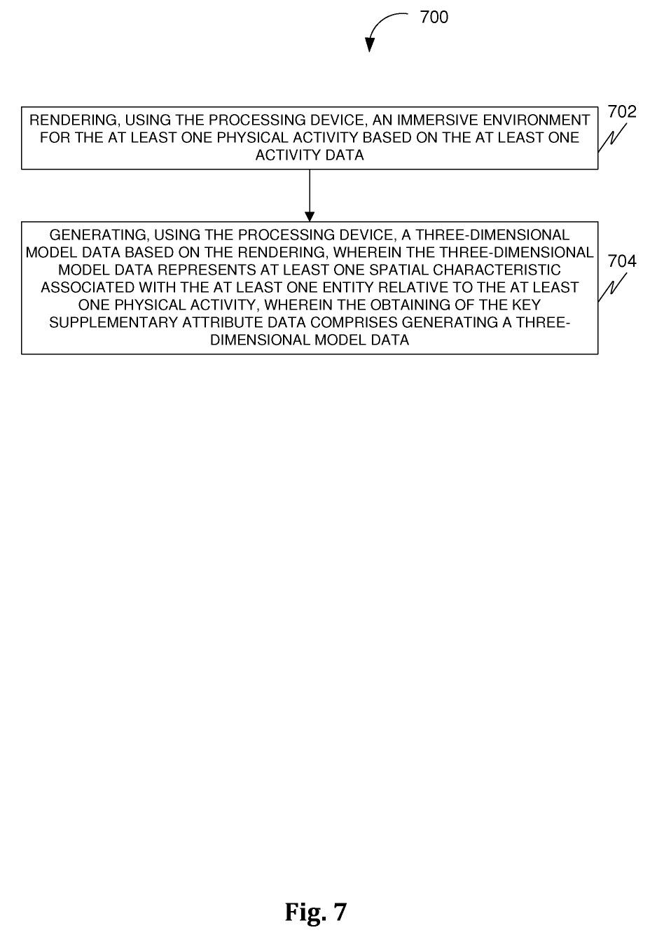

FIG. 7 illustrates a flowchart of a method 700 for facilitating metadata-driven interactive playback including generating, using the processing device 904, a three-dimensional model data, in accordance with some embodiments. Further, in some embodiments, the method 700 further may include a step 702 of rendering, using the processing device 904, an immersive environment for the one or more physical activities based on the one or more activity data. Further, in some embodiments, the method 700 further may include a step 704 of generating, using the processing device 904, a three-dimensional model data based on the rendering. Further, the three-dimensional model data represents one or more spatial characteristics 1306 associated with the one or more entities relative to the one or more physical activities. Further, the obtaining of the key supplementary attribute data includes generating a three-dimensional model data.

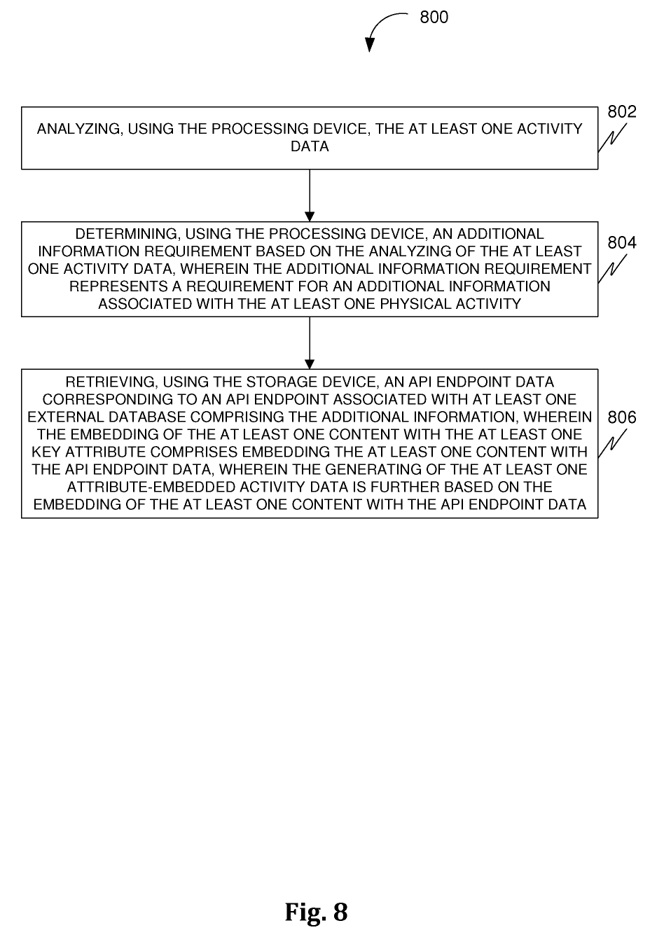

FIG. 8 illustrates a flowchart of a method 800 for facilitating metadata-driven interactive playback including retrieving, using the storage device 906, an API endpoint data corresponding to an API endpoint associated with at least one external database comprising the additional information, in accordance with some embodiments. Further, in some embodiments, the method 800 further may include a step 802 of analyzing, using the processing device 904, the one or more activity data. Further, in some embodiments, the method 800 further may include a step 804 of determining, using the processing device 904, an additional information requirement based on the analyzing of the one or more activity data. Further, the additional information requirement represents a requirement for an additional information associated with the one or more physical activities. Further, in some embodiments, the method 800 further may include a step 806 of retrieving, using the storage device 906, an API endpoint data corresponding to an API endpoint associated with one or more external databases comprising the additional information. Further, the embedding of the one or more contents with the one or more key attributes includes embedding the one or more contents with the API endpoint data. Further, the generating of the one or more attribute-embedded activity data may be further based on the embedding of the one or more contents with the API endpoint data.

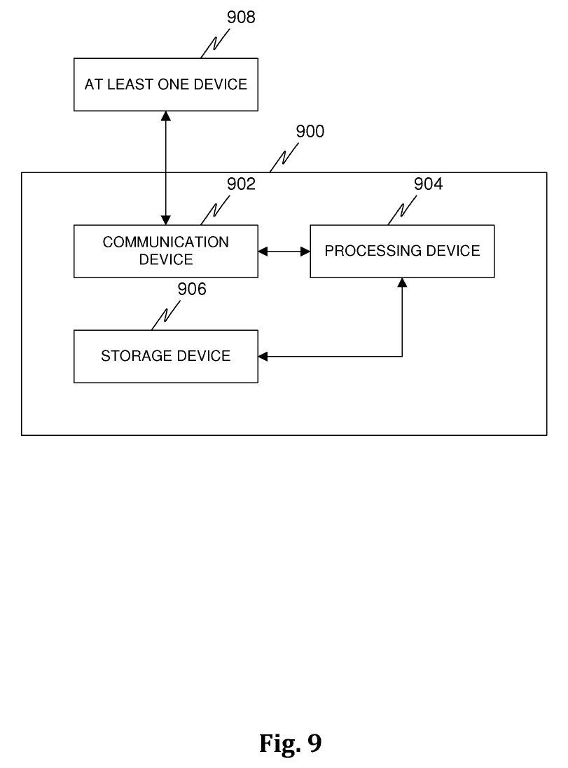

FIG. 9 illustrates a block diagram of a system 900 for facilitating metadata-driven interactive playback, in accordance with some embodiments. Accordingly, the system 900 may include a communication device 902. Further, the communication device 902 may be configured for receiving one or more activity data from one or more devices 908. Further, the one or more activity data represent one or more contents associated with one or more physical activities. Further, the communication device 902 may be configured for transmitting one or more enhanced activity data to the one or more devices 908. Further, the system 900 may include a processing device 904 communicatively coupled with the communication device 902. Further, the processing device 904 may be configured for obtaining a key supplementary attribute data based on the one or more activity data. Further, the key supplementary attribute data represents one or more key attributes associated with the one or more physical activities. Further, the processing device 904 may be configured for processing each of the one or more activity data and the key supplementary attribute data. Further, the processing device 904 may be configured for generating the one or more enhanced activity data based on the processing of each of the one or more activity data and the key supplementary attribute data. Further, the one or more enhanced activity data represent the one or more contents augmented with the one or more key attributes. Further, the system 900 may include a storage device 906 communicatively coupled with the processing device 904. Further, the storage device 906 may be configured for storing each of the one or more activity data and the one or more enhanced activity data.

In some embodiments, the one or more enhanced activity data includes one or more attribute-embedded activity data. Further, the processing of each of the one or more activity data and the key supplementary attribute data includes embedding the one or more contents with the one or more key attributes. Further, the generating of the one or more enhanced activity data includes generating of the one or more attribute-embedded activity data based on the embedding of the one or more contents with the one or more key attributes.

In some embodiments, the one or more physical activities may be associated with one or more entities. Further, the one or more key attributes include one or more performance parameters 1302 associated with the one or more entities relative to the one or more physical activities. Further, the processing of each of the one or more activity data and the key supplementary attribute data includes overlaying the one or more performance parameters 1302 onto the one or more contents associated with the one or more physical activities. Further, the generating of the one or more enhanced activity data may be further based on the overlaying.

Further, in some embodiments, the storage device 906 may be further configured for retrieving one or more historical activity data based on the one or more activity data. Further, the one or more historical activity data represent one or more historical contents associated with the one or more entities relative to the one or more physical activities. Further, the processing device 904 may be further configured for analyzing the one or more activity data and the one or more historical activity data using the one or more AI models. Further, the storage device 906 may be further configured for retrieving one or more historical activity data based on the one or more activity data. Further, the processing device 904 may be further configured for generating a comparison data based on the analyzing of the one or more activity data and the one or more historical activity data. Further, the comparison data represents one or more performance comparisons for the one or more entities relative to the one or more physical activities. Further, the obtaining of the key supplementary attribute data may be further based on the generating of the comparison data. Further, the overlaying of the one or more performance parameters 1302 onto the one or more contents includes overlaying the one or more performance comparisons onto the one or more contents.

In some embodiments, the one or more activity data includes a first activity phase data representing a first activity phase associated with a first time period and a second activity phase data representing a second activity phase associated with a second time period. Further, the second time period occurs later than the first time period. Further, the processing device 904 may be further configured for generating a transition data based on the first activity phase data and the second activity phase data. Further, the transition data represents a transition between the first activity phase and the second activity phase. Further, the obtaining of the key supplementary attribute data may be further based on the generating of the transition data. Further, the overlaying of the one or more performance parameters 1302 onto the one or more contents includes overlaying the transition data onto the one or more contents.

Further, in some embodiments, the processing device 904 may be further configured for determining an overlay parameter based on the first activity phase data and the second activity phase data. Further, the overlay parameter represents a degree of visual juxtaposition between the first activity phase and the second activity phase. Further, the processing device 904 may be further configured for generating a ghosted transition data based on the overlay parameter and the transition data. Further, the overlaying of the transition data onto the one or more contents includes overlaying the ghosted transition data onto the one or more contents.

In some embodiments, the key supplementary attribute data includes an activity viewing orientation data representing one or more orientations 1304 for viewing the one or more physical activities.

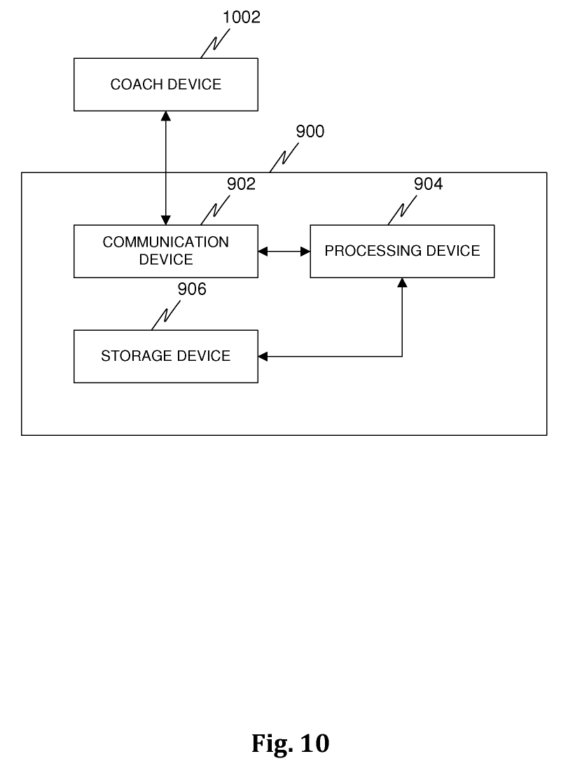

FIG. 10 illustrates a block diagram of a system 900 for facilitating metadata-driven interactive playback including a coach device 1002, in accordance with some embodiments. Further, in some embodiments, the one or more devices 908 may include the coach device 1002 associated with one or more coaches. Further, the one or more enhanced activity data may include a media feed data representing two or more media feeds. Further, each of the two or more media feeds may be configured to be encoded in two or more bitrate representations. Further, the coach device 1002 may include a coach-side presentation device configured for facilitating a simultaneous playback of at least two of the two or more media feeds. Further, the coach device 1002 further may include a coach-side processing device configured for monitoring one or more network performance parameters during the simultaneous playback. Further, the coach-side processing device may be configured for identifying a preferred bitrate representation for each of the two or more media feeds based on the monitoring of the one or more network performance parameters. Further, the coach-side processing device may be configured for adapting the simultaneous playback of the at least two of the two or more media feeds to the preferred bitrate representation based on the identifying of the preferred bitrate representation.

Further, in some embodiments, the processing device 904 may be further configured for rendering an immersive environment for the one or more physical activities based on the one or more activity data. Further, the processing device 904 may be further configured for generating a three-dimensional model data based on the rendering. Further, the three-dimensional model data represents one or more spatial characteristics 1306 associated with the one or more entities relative to the one or more physical activities. Further, the obtaining of the key supplementary attribute data includes generating a three-dimensional model data.

Further, in some embodiments, the processing device 904 may be further configured for analyzing the one or more activity data. Further, the processing device 904 may be further configured for determining an additional information requirement based on the analyzing of the one or more activity data. Further, the additional information requirement represents a requirement for an additional information associated with the one or more physical activities. Further, the storage device 906 may be further configured for retrieving an API endpoint data corresponding to an API endpoint associated with one or more external databases comprising the additional information. Further, the embedding of the one or more contents with the one or more key attributes includes embedding the one or more contents with the API endpoint data. Further, the generating of the one or more attribute-embedded activity data may be further based on the embedding of the one or more contents with the API endpoint data.

In some embodiments, the method 400 may further include retrieving, using the storage device 906, the key supplementary attribute data. Further, the obtaining of the key supplementary attribute data may be further based on the retrieving.

In some embodiments, the one or more activity data includes one or more video data representing one or more visual contents associated with the one or more physical activities.

In some embodiments, the one or more performance parameters 1302 include one or more of a speed, an angle, and a timing associated with the one or more entities relative to the one or more physical activities.

In some embodiments, the one or more entities include one or more of an athlete and an equipment associated with the one or more physical activities.

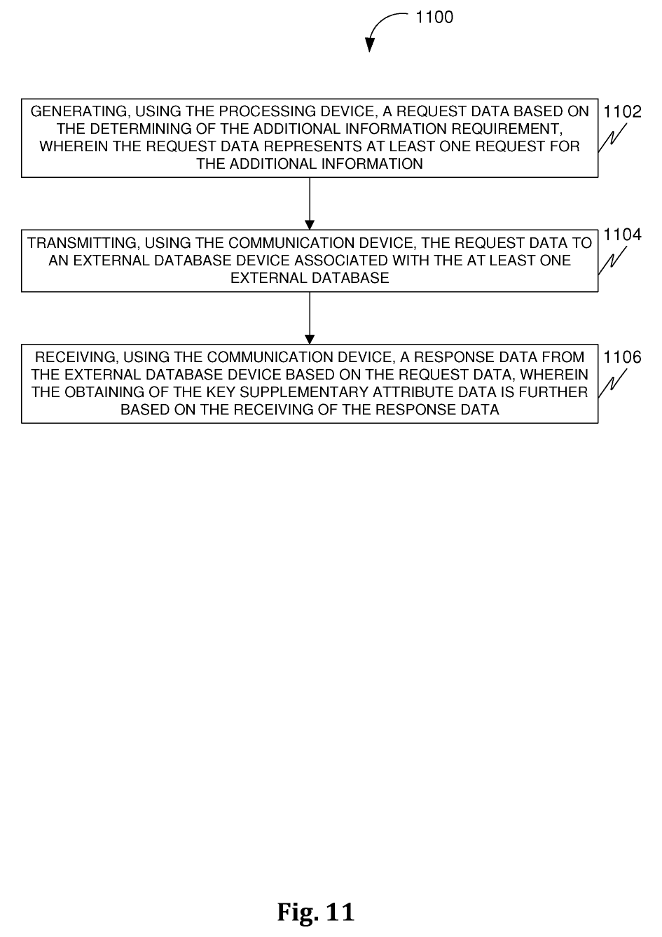

FIG. 11 illustrates a flowchart of a method 1100 for facilitating metadata-driven interactive playback including receiving, using the communication device 902, a response data from the external database device, in accordance with some embodiments. Further, in some embodiments, the method 1100 further may include a step 1102 of generating, using the processing device 904, a request data based on the determining of the additional information requirement. Further, the request data represents one or more requests for the additional information. Further, in some embodiments, the method 1100 further may include a step 1104 of transmitting, using the communication device 902, the request data to an external database device associated with the one or more external databases. Further, in some embodiments, the method 1100 further may include a step 1106 of receiving, using the communication device 902, a response data from the external database device based on the request data. Further, the obtaining of the key supplementary attribute data may be further based on the receiving of the response data.

In some embodiments, the request data includes an API call data representing a request to an API associated with the one or more external databases.

In some embodiments, the one or more activity data includes two or more activity data representing two or more activity phases. Further, the key supplementary attribute data includes a characteristic metadata corresponding to one or more key activity phases 1308 from the two or more activity phases. Further, the characteristic metadata includes a moment metadata corresponding to one or more key moments associated with the one or more key activity phases 1308. Further, the one or more key moments include a shot moment representing an execution of a shot during the one or more physical activities.

In some embodiments, the one or more key activity phases 1308 include a shot phase associated with the one or more physical activities. Further, the shot phase represents a shot-action associated with an instance during the one or more physical activities.

In some embodiments, the characteristic metadata further includes two or more characteristic metadata associated with two or more key activity phases. Further, each of the two or more characteristic metadata includes a time instance indicator corresponding to a time instance associated with each of the two or more key activity phases. Further, the two or more key activity phases include a first key activity phase and a second key activity phase. Further, the two or more characteristic data include one or more of a first characteristic data associated with the first key activity phase and a second characteristic data associated with the second key activity phase. Further, the first key activity phase may be associated with a first-time instance. Further, the second key activity phase may be associated with a second time instance. Further, the second time instance occurs later than the first time instance.

In some embodiments, the coach-side presentation device may be further configured for presenting the one or more enhanced activity data to the one or more coaches. Further, the enhanced activity data may be associated with the first key activity phase. Further, the coach device 1002 further includes a coach-side input device, which may be configured for generating a jump-to command data corresponding to a change from the first key activity phase to the second key activity phase associated with the one or more physical activities. Further, the coach-side processing device may be further configured for generating one or more modified enhanced activity data based on the jump-to command data. Further, the coach-side presentation device may be further configured for presenting the one or more modified enhanced activity data. Further, the one or more modified enhanced activity data may be associated with the second key activity phase.

In some embodiments, the one or more orientations 1304 for viewing include one or more of a shooter’s view orientation, a top-down/hoop view orientation, a defender’s view orientation, a side coach view orientation.

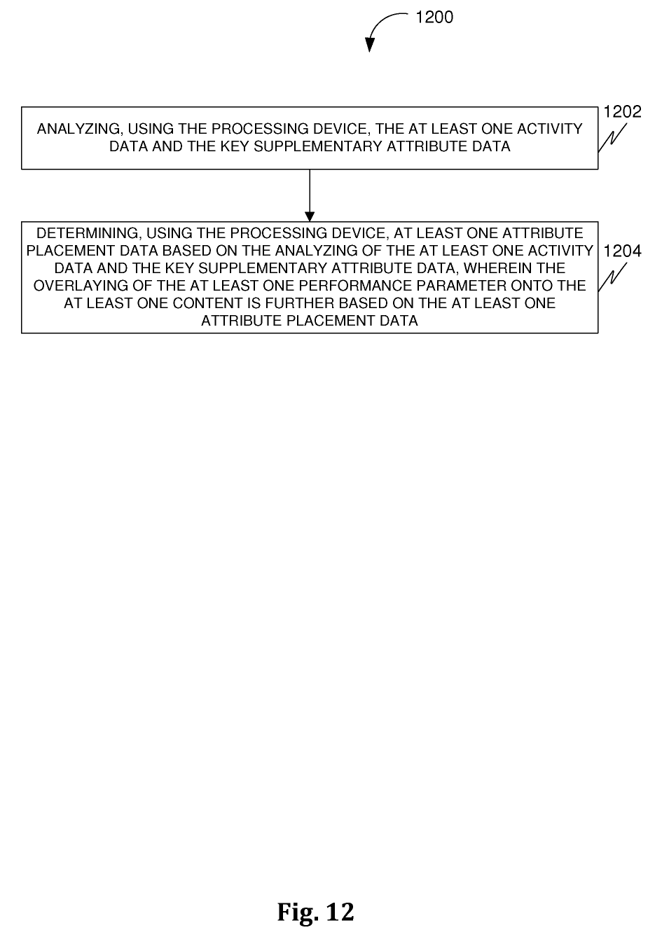

FIG. 12 illustrates a flowchart of a method 1200 for facilitating metadata-driven interactive playback including determining, using the processing device 904, at least one attribute placement data, in accordance with some embodiments. Further, in some embodiments, the method 1200 further may include a step 1202 of analyzing, using the processing device 904, the one or more activity data and the key supplementary attribute data. Further, in some embodiments, the method 1200 further may include a step 1204 of determining, using the processing device 904, one or more attribute placement data based on the analyzing of the one or more activity data and the key supplementary attribute data. Further, the overlaying of the one or more performance parameters 1302 onto the one or more contents may be further based on the one or more attribute placement data.

In some embodiments, the one or more activity data includes one or more content stream data corresponding to one or more content streams associated with the one or more physical activities.

In some embodiments, the rendering of the immersive environment includes utilizing Three.js for graphical rendering and utilizing a WebRTC protocol for real-time communication.

In some embodiments, the one or more network performance parameters include one or more of an available bandwidth, a latency, and a packet loss associated with the simultaneous playback.

In some embodiments, the one or more activity data includes two or more activity data corresponding to two or more views for the one or more physical activities.

In some embodiments, the processing of each of the at least one activity data and the key supplementary attribute data may include processing of each of the at least one activity data and the key supplementary attribute data using one or more artificial intelligence (AI) models. Further, the generating of the one or more enhanced activity data may include generating of the one or more enhanced activity data using the one or more AI models based on the processing of each of the at least one activity data and the key supplementary attribute data using one or more AI models.

In some embodiments, the key supplementary attribute data includes a key moment marker data representing one or more key moment markers corresponding to one or more of a timestamp and a timecode for one or more key moments associated with the one or more physical activities.

In some embodiments, the key moment marker data includes a phase marker data corresponding to one or more phases associated with the one or more physical activities and a time interval associated with the one or more phases.

In some embodiments, the activity viewing orientation data includes a view orientation metadata representing one or more pre-set perspectives for viewing the one or more physical activities.

In some embodiments, the one or more pre-set perspectives includes two or more pre-set perspectives. Further, the two or more pre-set perspectives includes a first perspective and a second perspective. Further, the presenting of the one or more enhanced activity data includes presenting of the one or more enhanced activity data in the first perspective. Further, the coach-side input device may be further configured for generating a view-switch command data representing a view-switch command corresponding to a change from the first perspective to the second perspective. Further, the generating of the one or more modified enhanced activity data may be further based on the view-switch command data. Further, the one or more modified enhanced activity data may be associated with the second perspective. Further, the presenting of the one or more modified enhanced activity data includes presenting of the one or more modified enhanced activity data in the second perspective.

In some embodiments, the rendering of the immersive environment for the one or more physical activities includes rendering one or more of a reconstructed performer model and a virtual camera corresponding to the one or more pre-set perspectives.

In some embodiments, the generating of the three-dimensional model data includes generating the three-dimensional model data using one or more of one or more multi-view inputs, a depth estimation, and one or more reconstruction models associated with the one or more physical activities. Further, the generating of the one or more three-dimensional model data further includes time-aligning the one or more spatial characteristics associated with the one or more physical activities to the one or more activity data.

In some embodiments, the one or more activity data includes two or more synchronized video feeds of an activity instance associated with the one or more physical activities.

In some embodiments, the adapting of the simultaneous playback of the at least two of the two or more media feeds includes aligning the simultaneous playback of the at least two of the two or more media feeds using one or more of one or more timestamps, one or more phase markers, one or more pose alignments, a cross-correlation.

In some embodiments, the method 400 may further include obtaining, using the processing device 904, one or more playback controls associated with the simultaneous playback. Further, the one or more playback controls may be further applied simultaneously across each of the at least two of the two or more media feeds.

In some embodiments, the one or more playback controls include one or more of play, pause, scrub, and jump-to.

In some embodiments, the one or more key moment markers may be configured to be mapped to a corresponding time-instance across the each of the at least two of the two or more media feeds.

In some embodiments, the one or more performance comparisons include a comparison of a current performance associated with the one or more entities with a historical performance associated with the one or more entities. Further, the generating of the comparison data includes rendering a side-by-side comparison of the current performance and the historical performance aligned by the one or more key moments.

In some embodiments, the one or more enhanced activity data includes a feature availability metadata indicating an availability of the one or more key attributes. Further, the enablement of the one or more key attributes may be further based on one or more of an entitlement and a subscription rate.

In some embodiments, the one or more enhanced activity data may be configured to be rendered for playback in the one or more devices. Further, method 700 further includes determining, using the processing device, a selection relative to a playback profile specifying a set of one or more of heuristics, measurements, overlays, and a key moment marker to be emphasized during the playback.

In some embodiments, the selection of the playback profile further specifies one or more threshold bands for highlighting one or more measurements. Further, the one or more threshold bands include a multi-level indicator comprising one or more of a red color, a yellow color, and a green color.

In some embodiments, the determining of the selection of the playback profile may be further based on one or more of an athlete age group, a skill level, a training objective, an injury/rehabilitation stage, a sport type, and an activity type.

In some embodiments, the playback profile may be configured to be provided as a pluggable configuration object. Further, the playback profile may be further configured to be loaded at runtime to control one or more of a playback navigation and overlay rendering associated with the playback.

In some embodiments, the method may further include generating, using the processing device, a supplementary feature data using the one or more of one or more three-dimensional key points, one or more quaternions, and one or more derived rotational metrics based on the processing. Further, the key supplementary attribute data includes the supplementary feature data.

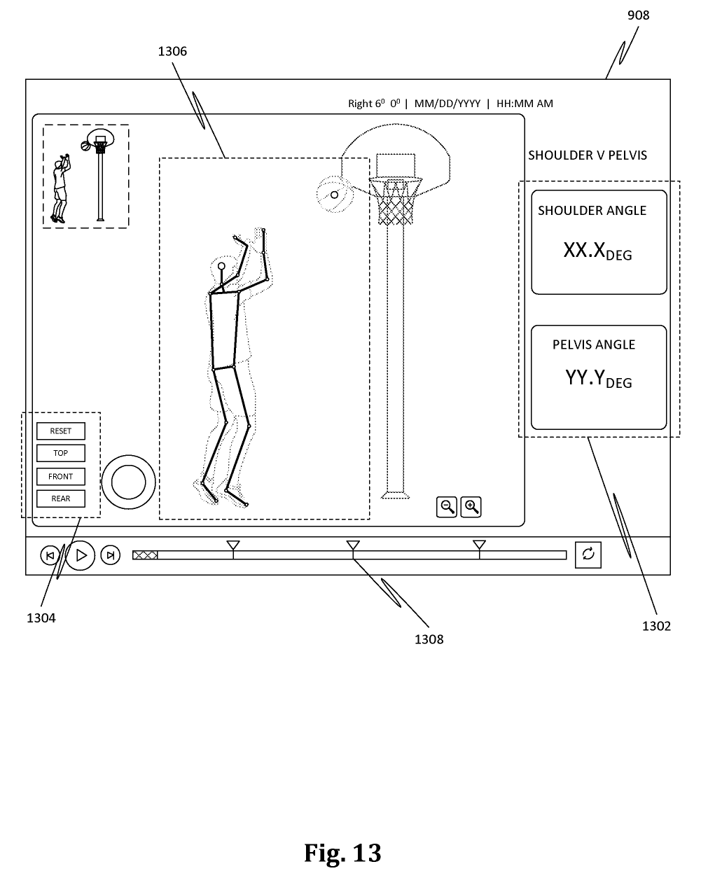

FIG. 13 illustrates the one or more devices 908 presenting the one or more enhanced activity data, in accordance with some embodiments. Further, the one or more enhanced activity data represents the at least one content associated with the one or more physical activities augmented with the one or more key attributes. Further, the one or more key attributes include one or more of the one or more performance parameters 1302, the one or more orientations 1304 for viewing, the one or more spatial characteristics 1306, and the one or more key activity phases 1308.

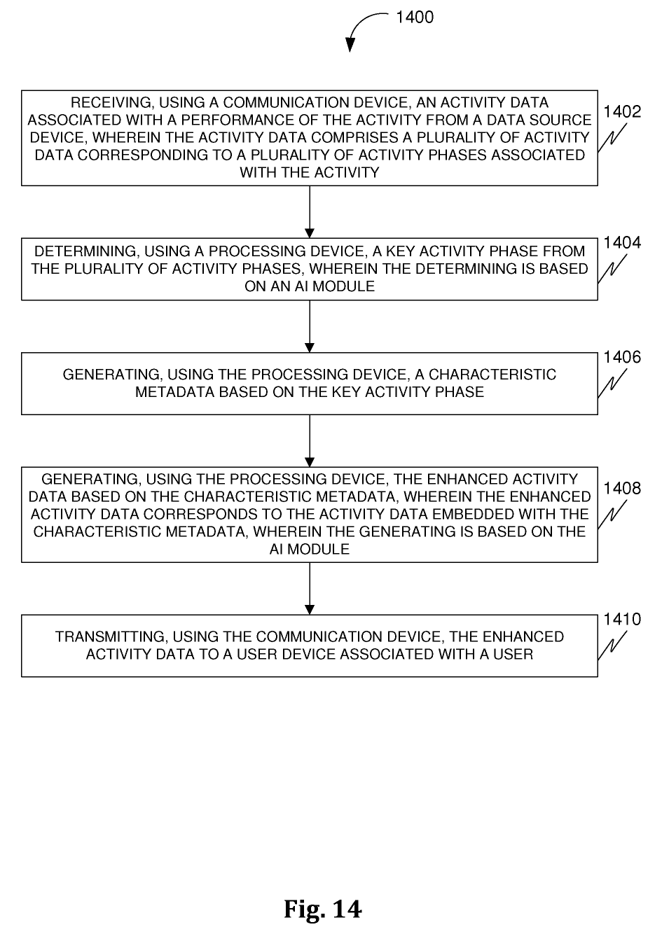

FIG. 14 illustrates a flowchart of a method 1400 of provisioning an enhanced activity data based on an activity, in accordance with some embodiments. Accordingly, the method 1400 may include a step 1402 of receiving, using the communication device 902, an activity data associated with a performance of the activity from a data source device. Further, the activity data includes two or more activity data corresponding to two or more activity phases associated with the activity. Further, the method 1400 may include a step 1404 of determining, using the processing device 904, a key activity phase from the two or more activity phases. Further, the determining may be based on an AI module. Further, the method 1400 may include a step 1406 of generating, using the processing device 904, a characteristic metadata based on the key activity phase. Further, the method 1400 may include a step 1408 of generating, using the processing device 904, the enhanced activity data based on the characteristic metadata. Further, the enhanced activity data corresponds to the activity data embedded with the characteristic metadata. Further, the generating may be based on the AI module. Further, the method 1400 may include a step 1410 of transmitting, using the communication device 902, the enhanced activity data to a user device associated with a user.

In some embodiments, the activity data includes a video data corresponding to a visual content associated with the activity.

In some embodiments, the characteristic metadata includes an activity metadata corresponding a key moment associated with the key activity phase. Further, the key moment includes a shot moment associated with the activity. Further, the shot moment corresponds to the execution of a shot associated with the performance of the activity.

In some embodiments, the key activity phase includes a shot phase associated with the activity. Further, the shot phase represents a shot-action associated with an instance during the performance of the activity.

In some embodiments, each of the two or more activity phases may be associated with two or more time instances. Further, the two or more activity phases include one or more of a first activity phase associated with a first time instance and a second activity phase associated with a second time instance. Further, the second time instance occurs later than the first time instance. Further, the method 1400 further comprising generating, using the processing device 904, a transition data based on each of the first activity phase and the second activity phase. Further, the transition data corresponds to a transition in the performance of the activity based on each of the first activity phase and the second activity phase. Further, the enhanced activity data includes the transition data. Further, the transition data includes a ghosted transition data representing the first activity phase juxtaposed with the second activity phase.

In some embodiments, the characteristic metadata includes two or more characteristic metadata associated with two or more key activity phases. Further, each of the two or more characteristic metadata includes a time instance indicator corresponding to a time instance associated with each of the two or more key activity phases. Further, the two or more characteristic data include one or more of a first characteristic data associated with the first key activity phase and a second characteristic data associated with the second key activity phase. Further, the first key activity phase may be associated with a first-time instance. Further, the second key activity phase may be associated with a second time instance. Further, the second time instance occurs later than the first time instance.

In some embodiments, the enhanced activity data may be configured to be presented on a user presentation device associated with the user device. Further, the enhanced activity data may be associated with the first key activity phase. Further, the user device includes a user input device which may be configured for receiving a jump-to command data corresponding to a change from the first key activity phase to the second key activity phase associated with the performance of the activity. Further, the user device further includes a user-processing device which may be configured for generating a modified enhanced activity data based on the jump-to command data. Further, the user presentation device may be further configured to present the modified enhanced activity data. Further, the modified enhanced activity data may be associated with the second key activity phase.

In some embodiments, the characteristic metadata includes an activity viewing orientation metadata corresponding to an activity viewing orientation associated with the performance of the activity. Further, the activity viewing orientation includes two or more activity viewing orientations. Further, the two or more activity viewing orientations include one or more of a first activity view and a second activity view.

In some embodiments, the method 1400 may further include generating, using the processing device 904, an insight data corresponding to an insight based on the performance of the activity. Further, the enhanced activity data further includes the activity data embedded with the insight data. Further, the generating of the insight data may be based on the AI module.

In some embodiments, the method 1400 may further include generating, using a processing device 904, a 3D model data based on the activity data. Further, the 3D model data represents a 3D model of an object associated with the activity. Further, the enhanced activity data further includes the activity data embedded with the 3D model data. Further, the generating of the 3D model data may be based on a rendering framework. Further, the generating of the 3D model data may be based on the AI module.

In some embodiments, the communication device 902 may be configured for receiving an activity data associated with a performance of the activity from a data source device. Further, the activity data includes two or more activity data corresponding to two or more activity phases associated with the activity. Further, the communication device 902 may be configured for transmitting the enhanced activity data to a user device associated with a user. Further, the processing device 904 may be configured for determining a key activity phase from the two or more activity phases. Further, the determining may be based on an AI module. Further, the processing device 904 may be configured for generating a characteristic metadata based on the key activity phase. Further, the processing device 904 may be configured for generating the enhanced activity data based on the characteristic metadata. Further, the enhanced activity data corresponds to the activity data embedded with the characteristic metadata. Further, the generating may be based on the AI module.

In some embodiments, the activity data includes a video data corresponding to a visual content associated with the activity.

In some embodiments, the characteristic metadata includes an activity metadata corresponding to a key moment associated with the key activity phase. Further, the key moment includes a shot moment associated with the activity. Further, the shot moment corresponds to the execution of a shot associated with the performance of the activity.

In some embodiments, the key activity phase includes a shot phase associated with the activity. Further, the shot phase represents a shot-action associated with an instance during the performance of the activity.

In some embodiments, each of the two or more activity phases may be associated with two or more time instances. Further, the two or more activity phases include one or more of a first activity phase associated with a first time instance and a second activity phase associated with a second time instance. Further, the second time instance occurs later than the first time instance. Further, the method 1400 further comprising generating, using the processing device 904, a transition data based on each of the first activity phase and the second activity phase. Further, the transition data corresponds to a transition in the performance of the activity based on each of the first activity phase and the second activity phase. Further, the enhanced activity data includes the transition data. Further, the transition data includes a ghosted transition data representing the first activity phase juxtaposed with the second activity phase.

In some embodiments, the characteristic metadata includes two or more characteristic metadata associated with two or more key activity phases. Further, each of the two or more characteristic metadata includes a time instance indicator corresponding to a time instance associated with each of the two or more key activity phases. Further, the two or more characteristic data include one or more of a first characteristic data associated with the first key activity phase and a second characteristic data associated with the second key activity phase. Further, the first key activity phase may be associated with a first time instance. Further, the second key activity phase may be associated with a second time instance. Further, the second time instance occurs later than the first time instance.

In some embodiments, the enhanced activity data may be configured to be presented on a user presentation device associated with the user device. Further, the enhanced activity data may be associated with the first key activity phase. Further, the user device includes a user input device which may be configured for receiving a jump-to command data corresponding to a change from the first key activity phase to the second key activity phase associated with the performance of the activity. Further, the user device further includes a user-processing device which may be configured for generating a modified enhanced activity data based on the jump-to command data. Further, the user presentation device may be further configured to present the modified enhanced activity data. Further, the modified enhanced activity data may be associated with the second key activity phase.

In some embodiments, the characteristic metadata includes an activity viewing orientation metadata corresponding to an activity viewing orientation associated with the performance of the activity. Further, the activity viewing orientation includes two or more activity viewing orientations. Further, the two or more activity viewing orientations include one or more of a first activity view and a second activity view.

In some embodiments, the processing device 904 may be further configured for generating an insight data corresponding to an insight based on the performance of the activity. Further, the enhanced activity data further includes the activity data embedded with the insight data. Further, the generating of the insight data may be based on the AI module.

In some embodiments, the processing device 904 may be further configured for generating a 3D model data based on the activity data. Further, the 3D model data represents a 3D model of an object associated with the activity. Further, the enhanced activity data further includes the activity data embedded with the 3D model data. Further, the generating of the 3D model data may be based on a rendering framework. Further, the generating of the 3D model data may be based on the AI module.

In some embodiments, the shot moment includes a jump shot moment associated with the activity.

In some embodiments, the shot phase includes one or more of a transfer phase, a pocket phase and a release phase.

In some embodiments, the. Further, the enhanced activity data may be configured to be presented on a user presentation device associated with the user device. Further, the enhanced activity data may be associated with the first activity view.

In some embodiments, the user device includes a user input device which may be configured for receiving a view-switch command corresponding to a change in the activity viewing orientation from the first activity view to the second activity view.

In some embodiments, the user device further includes a user-processing device which may be configured for generating a view-modified enhanced activity data based on the view-switch command data. Further, the user presentation device may be further configured to present the view-modified enhanced activity data. Further, the view-modified enhanced activity data may be associated with the second activity view.

In some embodiments, the two or more activity viewing orientations include one or more of a shooter’s view, top-down/hoop view, a defender’s view and a side-coach view.

In some embodiments, the enhanced activity data includes the activity data overlaid with the insight data.

In some embodiments, the enhanced activity data includes the insight data integrated into the activity data.

In some embodiments, the insight data includes one or more of a speed data, an angle data and a timing data. Further, the speed data corresponds to a speed of a performer associated with the activity. Further, the angle data corresponds to an angle subtended by the performer body part comprised within the performer with one or more of a performer body and an environment associated with the performance of the activity. Further, the timing data corresponds to a timing associated with the performer based on the performance of the activity.

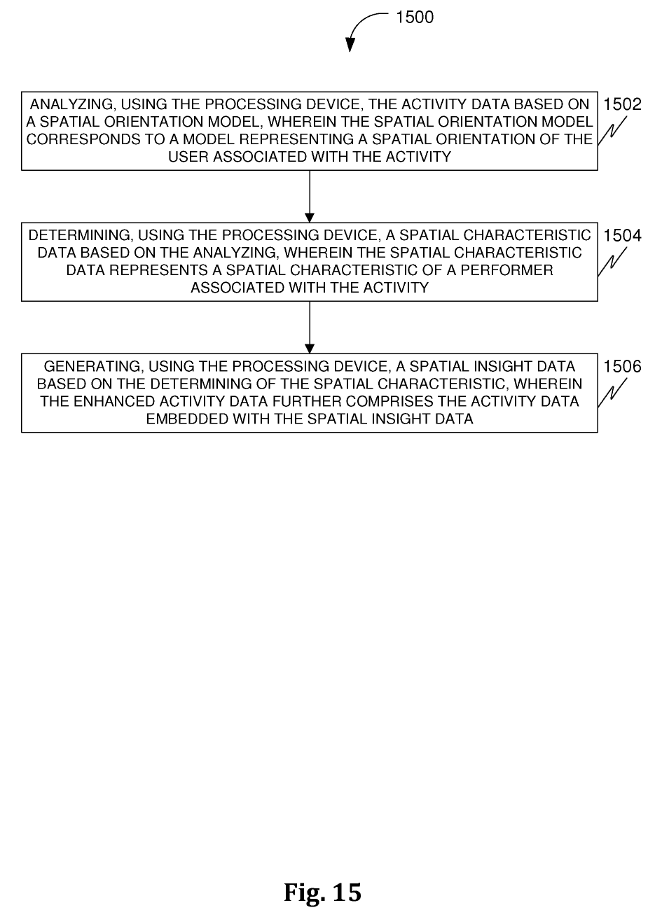

FIG. 15 illustrates a flowchart of a method 1500 of provisioning an enhanced activity data based on an activity including generating, using the processing device 904, a spatial insight data, in accordance with some embodiments. Further, in some embodiments, the method 1500 further may include a step 1502 of analyzing, using the processing device 904, the activity data based on a spatial orientation model. Further, the spatial orientation model corresponds to a model representing a spatial orientation of the user associated with the activity. Further, in some embodiments, the method 1500 further may include a step 1504 of determining, using the processing device 904, a spatial characteristic data based on the analyzing. Further, the spatial characteristic data represent a spatial characteristic of a performer associated with the activity. Further, in some embodiments, the method 1500 further may include a step 1506 of generating, using the processing device 904, a spatial insight data based on the determining of the spatial characteristic. Further, the enhanced activity data further includes the activity data embedded with the spatial insight data.

In some embodiments, the rendering framework includes one or more of a Babylon.js framework, a Three.js framework, a PixiJS framework, an A-Frame framework, a Unity framework, and an Unreal Engine.

In some embodiments, the object includes one or more of the user and an object associated with the activity.

In some embodiments, the activity includes a sport.

In some embodiments, the object includes a sports equipment.

In some embodiments, the method 1400 may further include retrieving, using a storage device, an API endpoint data corresponding to an API endpoint. Further, the enhanced activity data further includes the activity data embedded with the API endpoint data.

In some embodiments, the enhanced activity data may be further configured to be presented on a web interface associated with the user.

In some embodiments, the data source device includes a camera.

Although the invention has been explained in relation to its preferred embodiment, it is to be understood that many other possible modifications and variations can be made without departing from the spirit and scope of the invention as hereinafter claimed.

What is claimed is:

1. A method for facilitating metadata-driven interactive playback, the method comprising:
receiving, using a communication device, at least one activity data from at least one device, wherein the at least one activity data represents at least one content associated with at least one physical activity;
obtaining, using a processing device, a key supplementary attribute data based on the at least one activity data, wherein the key supplementary attribute data represents at least one key attribute supplementing the at least one content;
processing, using the processing device, each of the at least one activity data and the key supplementary attribute data;
generating, using the processing device, at least one enhanced activity data based on the processing of each of the at least one activity data and the key supplementary attribute data, wherein the at least one enhanced activity data represents the at least one content augmented with the at least one key attribute;
storing, using a storage device, each of the at least one activity data and the at least one enhanced activity data; and
transmitting, using the communication device, the at least one enhanced activity data to the at least one device.

2. The method of claim 1, wherein the at least one enhanced activity data comprises at least one attribute-embedded activity data, wherein the processing of each of the at least one activity data and the key supplementary attribute data comprises embedding the at least one content with the at least one key attribute, wherein the generating of the at least one enhanced activity data comprises generating of the at least one attribute-embedded activity data based on the embedding of the at least one content with the at least one key attribute.

3. The method of claim 2, wherein the at least one physical activity is associated with at least one entity, wherein the at least one key attribute comprises at least one performance parameter associated with the at least one entity relative to the at least one physical activity, wherein the processing of each of the at least one activity data and the key supplementary attribute data comprises overlaying the at least one performance parameter onto the at least one content associated with the at least one physical activity, wherein the generating of the at least one enhanced activity data is further based on the overlaying.

4. The method of claim 3 further comprising:
retrieving, using the storage device, at least one historical activity data based on the at least one activity data, wherein the at least one historical activity data represents at least one historical content associated with the at least one entity relative to the at least one physical activity;
analyzing, using the processing device, the at least one activity data and the at least one historical activity data using at least one artificial intelligence (AI) model; and
generating, using the processing device, a comparison data based on the analyzing of the at least one activity data and the at least one historical activity data, wherein the comparison data represents at least one performance comparison for the at least one entity relative to the at least one physical activity, wherein the obtaining of the key supplementary attribute data is further based on the generating of the comparison data, wherein the overlaying of the at least one performance parameter onto the at least one content comprises overlaying the at least one performance comparison onto the at least one content.

5. The method of claim 3, wherein the at least one activity data comprises a first activity phase data representing a first activity phase associated with a first time period and a second activity phase data representing a second activity phase associated with a second time period, wherein the second time period occurs later than the first time period, wherein the method further comprises generating, using the processing device, a transition data based on the first activity phase data and the second activity phase data, wherein the transition data represents a transition between the first activity phase and the second activity phase, wherein the obtaining of the key supplementary attribute data is further based on the generating of the transition data, wherein the overlaying of the at least one performance parameter onto the at least one content comprises overlaying the transition data onto the at least one content.

6. The method of claim 5 further comprising:
determining, using the processing device, an overlay parameter based on the first activity phase data and the second activity phase data, wherein the overlay parameter represents a degree of visual juxtaposition between the first activity phase and the second activity phase; and
generating, using the processing device, a ghosted transition data based on the overlay parameter and the transition data, wherein the overlaying of the transition data onto the at least one content comprises overlaying the ghosted transition data onto the at least one content.

7. The method of claim 1, wherein the key supplementary attribute data comprises an activity viewing orientation data representing at least one orientation for viewing the at least one physical activity.

8. The method of claim 1, wherein the at least one device comprises a coach device associated with at least one coach, wherein the at least one enhanced activity data comprises a media feed data representing a plurality of media feeds, wherein each of the plurality of media feeds is configured to be encoded in a plurality of bitrate representations, wherein the coach device comprises a coach-side presentation device configured for facilitating a simultaneous playback of at least two of the plurality of media feeds, wherein the coach device further comprises a coach-side processing device configured for:
monitoring at least one network performance parameter during the simultaneous playback;
identifying a preferred bitrate representation for each of the plurality of media feeds based on the monitoring of the at least one network performance parameter; and
adapting the simultaneous playback of the at least two of the plurality of media feeds to the corresponding preferred bitrate representation based on the identifying of the preferred bitrate representation.

9. The method of claim 3 further comprising:
rendering, using the processing device, an immersive environment for the at least one physical activity based on the at least one activity data; and
generating, using the processing device, a three-dimensional model data based on the rendering, wherein the three-dimensional model data represents at least one spatial characteristic associated with the at least one entity relative to the at least one physical activity, wherein the obtaining of the key supplementary attribute data comprises generating a three-dimensional model data.

10. The method of claim 2 further comprising:
analyzing, using the processing device, the at least one activity data;
determining, using the processing device, an additional information requirement based on the analyzing of the at least one activity data, wherein the additional information requirement represents a requirement for an additional information associated with the at least one physical activity; and
retrieving, using the storage device, an API endpoint data corresponding to an API endpoint associated with at least one external database comprising the additional information, wherein the embedding of the at least one content with the at least one key attribute comprises embedding the at least one content with the API endpoint data, wherein the generating of the at least one attribute-embedded activity data is further based on the embedding of the at least one content with the API endpoint data.

11. A system for facilitating metadata-driven interactive playback, the system comprising:
a communication device configured for:
receiving at least one activity data from at least one device, wherein the at least one activity data represents at least one content associated with at least one physical activity; and
transmitting at least one enhanced activity data to the at least one device;
a processing device communicatively coupled with the communication device, wherein the processing device is configured for:
obtaining a key supplementary attribute data based on the at least one activity data, wherein the key supplementary attribute data represents at least one key attribute associated with the at least one physical activity;
processing each of the at least one activity data and the key supplementary attribute data; and
generating the at least one enhanced activity data based on the processing of each of the at least one activity data and the key supplementary attribute data, wherein the at least one enhanced activity data represents the at least one content augmented with the at least one key attribute; and
a storage device communicatively coupled with the processing device, wherein the storage device is configured for storing each of the at least one activity data and the at least one enhanced activity data.

12. The system of claim 11, wherein the at least one enhanced activity data comprises at least one attribute-embedded activity data, wherein the processing of each of the at least one activity data and the key supplementary attribute data comprises embedding the at least one content with the at least one key attribute, wherein the generating of the at least one enhanced activity data comprises generating of the at least one attribute-embedded activity data based on the embedding of the at least one content with the at least one key attribute.

13. The system of claim 12, wherein the at least one physical activity is associated with at least one entity, wherein the at least one key attribute comprises at least one performance parameter associated with the at least one entity relative to the at least one physical activity, wherein the processing of each of the at least one activity data and the key supplementary attribute data comprises overlaying the at least one performance parameter onto the at least one content associated with the at least one physical activity, wherein the generating of the at least one enhanced activity data is further based on the overlaying.

14. The system of claim 13, wherein the storage device is further configured for retrieving at least one historical activity data based on the at least one activity data, wherein the at least one historical activity data represents at least one historical content associated with the at least one entity relative to the at least one physical activity, wherein the processing device is further configured for:
analyzing the at least one activity data and the at least one historical activity data using at least one artificial intelligence (AI) model; and
generating a comparison data based on the analyzing of the at least one activity data and the at least one historical activity data, wherein the comparison data represents at least one performance comparison for the at least one entity relative to the at least one physical activity, wherein the obtaining of the key supplementary attribute data is further based on the generating of the comparison data, wherein the overlaying of the at least one performance parameter onto the at least one content comprises overlaying the at least one performance comparison onto the at least one content.

15. The system of claim 13, wherein the at least one activity data comprises a first activity phase data representing a first activity phase associated with a first time period and a second activity phase data representing a second activity phase associated with a second time period, wherein the second time period occurs later than the first time period, wherein the processing device is further configured for generating a transition data based on the first activity phase data and the second activity phase data, wherein the transition data represents a transition between the first activity phase and the second activity phase, wherein the obtaining of the key supplementary attribute data is further based on the generating of the transition data, wherein the overlaying of the at least one performance parameter onto the at least one content comprises overlaying the transition data onto the at least one content.

16. The system of claim 15, wherein the processing device is further configured for:
determining an overlay parameter based on the first activity phase data and the second activity phase data, wherein the overlay parameter represents a degree of visual juxtaposition between the first activity phase and the second activity phase; and
generating a ghosted transition data based on the overlay parameter and the transition data, wherein the overlaying of the transition data onto the at least one content comprises overlaying the ghosted transition data onto the at least one content.

17. The system of claim 11, wherein the key supplementary attribute data comprises an activity viewing orientation data representing at least one orientation for viewing the at least one physical activity.

18. The system of claim 11, wherein the at least one device comprises a coach device associated with at least one coach, wherein the at least one enhanced activity data comprises a media feed data representing a plurality of media feeds, wherein each of the plurality of media feeds is configured to be encoded in a plurality of bitrate representations, wherein the coach device comprises a coach-side presentation device configured for facilitating a simultaneous playback of at least two of the plurality of media feeds, wherein the coach device further comprises a coach-side processing device configured for:
monitoring at least one network performance parameter during the simultaneous playback;
identifying a preferred bitrate representation for each of the plurality of media feeds based on the monitoring of the at least one network performance parameter; and
adapting the simultaneous playback of the at least two of the plurality of media feeds to the corresponding preferred bitrate representation based on the identifying of the preferred bitrate representation.

19. The system of claim 13, wherein the processing device is further configured for:
rendering an immersive environment for the at least one physical activity based on the at least one activity data; and
generating a three-dimensional model data based on the rendering, wherein the three-dimensional model data represents at least one spatial characteristic associated with the at least one entity relative to the at least one physical activity, wherein the obtaining of the key supplementary attribute data comprises generating a three-dimensional model data.

20. The system of claim 12, wherein the processing device is further configured for:
analyzing the at least one activity data; and
determining an additional information requirement based on the analyzing of the at least one activity data, wherein the additional information requirement represents a requirement for an additional information associated with the at least one physical activity, wherein the storage device is further configured for retrieving an API endpoint data corresponding to an API endpoint associated with at least one external database comprising the additional information, wherein the embedding of the at least one content with the at least one key attribute comprises embedding the at least one content with the API endpoint data, wherein the generating of the at least one attribute-embedded activity data is further based on the embedding of the at least one content with the API endpoint data.
